(19) United States
(12) Patent Application Publication
(10) Pub. No.: US 2026/0289883 A1
(43) Pub. Date: Sep. 24, 2026

(54) SYSTEM

(71) Applicant: SoftBank Group Corp., Tokyo (JP)

(72) Inventor: Yudai HATTA, Tokyo (JP)

(73) Assignee: SoftBank Group Corp., Tokyo (JP)

(21) Appl. No.: 19/567,008

(22) Filed: Mar. 14, 2026

(30) Foreign Application Priority Data
Mar. 19, 2025 (JP) 2025-045282

(51) Int. Cl. G06T 13/20; G06F 40/205; G06F 40/253; G06F 40/284; G06F 40/40; G06T 13/40; G06V 10/82; G06V 40/16; G10L 25/21; G10L 25/87; G10L 25/90

(52) U.S. Cl. CPC G06T 13/205; G06F 40/205; G06F 40/253; G06F 40/284; G06F 40/40; G06T 13/40; G06V 10/82; G06V 40/171; G10L 25/21; G10L 25/87; G10L 25/90

(57) ABSTRACT

A system comprising a processor, wherein the processor is configured to: collect, from a call, a voice characteristic and a speaking tone of a user and convert the collected voice characteristic and speaking tone into voice feature data, analyze text associated with the user to extract a personal text style feature of the user from the text and generate text style feature data, and generate a virtual person representing the user based on past image data associated with the user.

### CROSS-REFERENCE TO RELATED APPLICATION

This application is based on and claims priority under 35 USC 119 from Japanese Patent Application No. 2025-045282 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication systems and avatar generation systems are limited in their ability to reproduce an individual user's unique communication style in an integrated manner. Existing techniques typically handle only one modality, such as voice cloning, text style imitation, or static avatar creation from images, in isolation. As a result, such techniques cannot provide a coherent pseudo communication experience that accurately reflects a specific user's characteristic voice tone, speaking style, and personal text expression style while also visually representing the user via a virtual person generated from images. Furthermore, in conventional systems, there is no unified mechanism whereby collected multimodal data, including call audio, user text, and past images, is analyzed and converted into reusable feature data that can be used to both generate a virtual person and drive communication in the user's style. In addition, existing systems do not sufficiently utilize generative artificial intelligence models in combination with user-specific text style features to generate text that reproduces the user's individual writing style. Therefore, there is a need for a system that collects and analyzes multimodal user data, generates a virtual person representing the user, and provides a pseudo communication experience by reproducing the user's voice characteristics, speaking tone, and text style in an integrated manner.

### SUMMARY

To solve the foregoing problems, a system is provided comprising a processor, wherein the processor is configured to collect, from a call, a voice characteristic and a speaking tone of a user and convert the collected voice characteristic and speaking tone into voice feature data. The processor is further configured to analyze text associated with the user to extract a personal text style feature of the user from the text and to generate text style feature data. In addition, the processor is configured to generate a virtual person representing the user based on past image data associated with the user, thereby constructing a virtual person that visually reflects features of the user. The processor is also configured, based on the voice feature data, to reproduce the collected voice characteristic and speaking tone of the user and to provide a pseudo communication experience with the virtual person by voice or by text. Moreover, the processor is configured to generate a prompt sentence for instructing a generative artificial intelligence model to generate text in accordance with the personal text style feature of the user, and to generate text using the generative artificial intelligence model based on the generated prompt sentence. Through these means, the system realizes an integrated pseudo communication environment in which the user's characteristic voice, speaking tone, and personal text style are reproduced in association with a virtual person generated from the user's past images.

The term “system” refers to an integrated combination of hardware and software components including at least one processor and associated storage, communication interfaces, and programs, configured to execute the functions described in the claims.

The term “processor” refers to any hardware element or combination of elements capable of executing instructions, including but not limited to a central processing unit (CPU), a graphics processing unit (GPU), a digital signal processor (DSP), an application specific integrated circuit (ASIC), a field programmable gate array (FPGA), or a combination thereof.

The term “call” refers to an audio communication session between two or more parties conducted via a communication network, including but not limited to a telephone call, a voice over IP (VoIP) call, or a voice chat session.

The term “voice characteristic” refers to a feature or set of features representing acoustic properties of a user's voice, including, for example, pitch, timbre, formant structure, speaking rate, and loudness distribution.

The term “speaking tone” refers to a style-related aspect of how a user speaks during a call, including but not limited to intonation patterns, stress placement, rhythm, and prosodic variations that distinguish the user's way of speaking.

The term “voice feature data” refers to data generated by the processor that encodes the voice characteristic and speaking tone of a user in a form suitable for storage, analysis, and reproduction by the system.

The term “text associated with the user” refers to text data created, sent, received, or otherwise attributable to a specific user, such as chat messages, emails, posts, or other written communications.

The term “personal text style feature” refers to one or more characteristics extracted from the text associated with the user that represent the user's individual manner of writing, including vocabulary usage, sentence length, typical phrases, emoji usage, formality level, and tone.

The term “text style feature data” refers to data generated by the processor that encodes the personal text style feature of the user in a form suitable for storage, analysis, and use in text generation.

The term “past image data” refers to one or more images or photographs captured or stored before a given time and associated with the user, including still images obtained from cameras, smartphones, or other imaging devices.

The term “virtual person” refers to a computer-generated representation of a user, including at least a visual avatar model that reflects one or more physical or stylistic characteristics of the user derived from the past image data.

The term “pseudo communication experience” refers to an interaction provided by the system in which a user or another party communicates with the virtual person through generated voice or text that imitates the original user's communication style, without direct real-time participation by the original user.

The term “generative artificial intelligence model” refers to a model implemented by machine learning or deep learning that is configured to generate new content, such as text, based on input data or instructions, including but not limited to large language models and sequence-to-sequence models.

The term “prompt sentence” refers to a text input generated by the processor and supplied to the generative artificial intelligence model, the text input specifying constraints, instructions, or style requirements to cause the generative artificial intelligence model to generate text in accordance with the personal text style feature of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

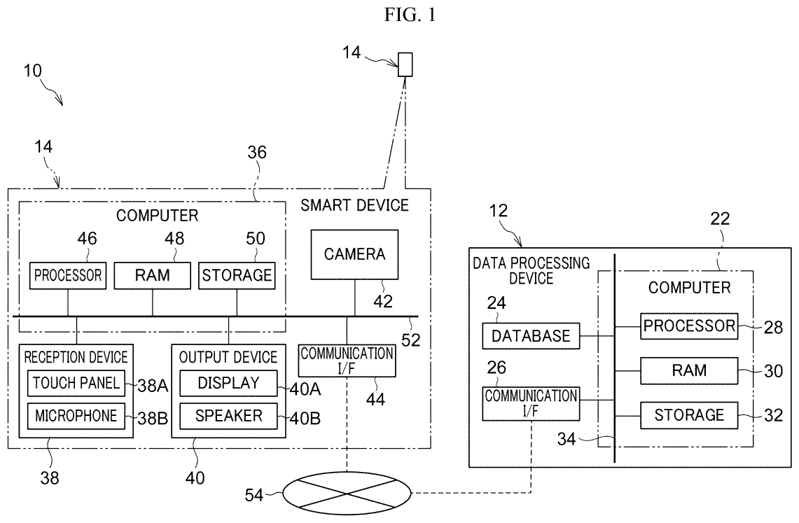

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

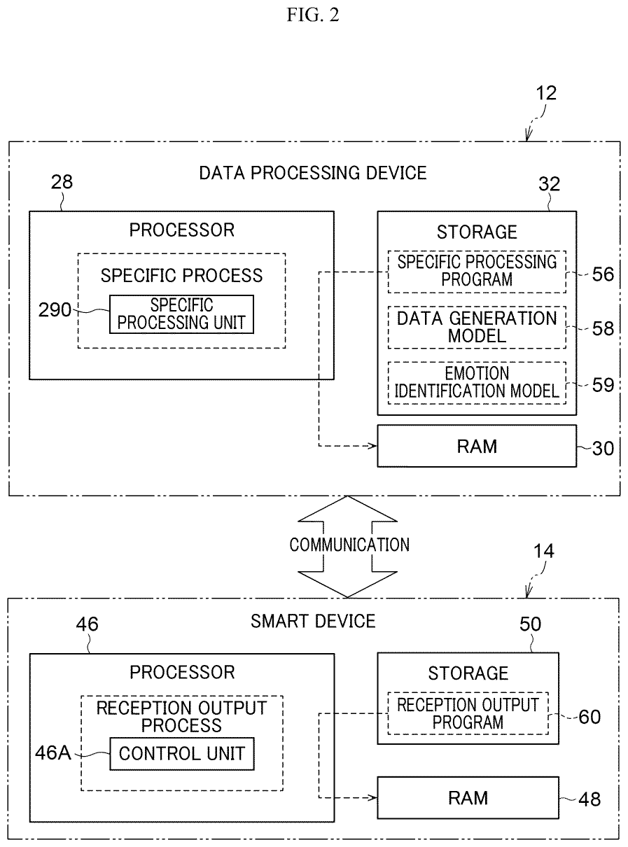

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional communication and content generation systems, there are several technical limitations in how speech, text, and image data of a person are processed and reused. First, typical speech analysis pipelines either store raw audio or high-fidelity reconstructions of speech content and identity, which increases the risk of exposing personally identifiable information and requires complex access control and data governance. Second, in many systems, acoustic analysis, text style analysis, and image-based appearance analysis are performed in isolation, without a unified data model that can be reused across downstream components such as generative models, speech synthesis engines, or virtual character renderers. As a result, the systems cannot efficiently reuse previously captured behavioral characteristics of a user's voice, writing style, and appearance to generate consistent and privacy-preserving virtual representations.

Third, general-purpose generative AI models are typically driven by unstructured natural language prompts authored manually by users or developers. These prompts are not systematically derived from structured, anonymized feature data that represents how a user speaks or writes. Consequently, the generative AI models do not consistently reflect the user's characteristic speaking tone or writing style, and the prompt engineering process is ad hoc, error-prone, and difficult to scale. Fourth, existing virtual person or avatar systems often rely on static templates or manually tuned parameters and do not automatically integrate non-personal acoustic feature data and non-personal document feature data into a coherent control scheme for generating both content and behavior.

From a computer technology standpoint, these limitations lead to several concrete problems:
(i) inefficient use of storage and processing resources due to the need to handle raw or semi-raw personal data; (ii) lack of an intermediate, machine-readable representation that captures behaviorally meaningful, but non-identifying, acoustic and textual features; (iii) absence of a systematic mechanism in the server to generate prompt sentences for generative AI models based on such structured feature data; and (iv) difficulty in configuring downstream synthesis and rendering components (such as speech synthesis engines and virtual character controllers) in a consistent and automated manner. There is therefore a need for an improved computer-implemented system and server-side processing architecture that (a) converts multimodal call data into non-personal feature data, (b) manages this data in a unified information management mechanism, and (c) automatically exploits this data to generate prompts and control signals for generative AI models and synthesis components, while enhancing privacy, modularity, and computational efficiency.

The specific processing by the specific processing unit 290 of the data processing device 12 in Example 1 is realized by the following means.

The present invention provides a server comprising a processor configured to receive, from a terminal via a secure communication path, acoustic information captured during a call, convert the acoustic information into acoustic data in a format that excludes personally identifiable information, and store the acoustic data in a storage device; the processor further being configured to apply an acoustic analysis program and an external acoustic analysis service to the acoustic data so as to calculate acoustic feature quantities including at least pitch, speaking rate, intonation, intensity, and pausing pattern, to calculate characteristic quantities indicative of a speaking tone, and to structure the characteristic quantities as non-personal acoustic feature data from which information having personal identifiability has been removed; the processor further being configured to register the non-personal acoustic feature data, together with an identifier and time information, in an information management mechanism on the storage device in a format that enables search and reuse; the processor further being configured to apply a document analysis program to document data so as to extract document feature quantities indicative of at least writing style, vocabulary selection, and syntactic structure, to store the document feature quantities as non-personal document feature data in association with the information management mechanism, and to apply an image analysis program to image data so as to extract appearance feature quantities of a person and to generate virtual person generation data defining at least an appearance and a behavior of a virtual person based on the appearance feature quantities, the non-personal acoustic feature data, and the non-personal document feature data; and the processor further being configured to generate a prompt sentence to be input to a generative AI model by using the non-personal document feature data, to supply the prompt sentence to the generative AI model so as to obtain generated document data reflecting the document feature quantities, and to make the generated document data available in association with the virtual person generation data. This enables the server to transform raw multimodal user data into unified, non-personal feature representations and to automatically drive generative AI models and synthesis components with system-generated prompts and control parameters, thereby improving privacy protection, computational efficiency, consistency of virtual person behavior, and overall performance of the computer-implemented communication and content generation system.

The term “acoustic information” refers to analog or digital data representing sound captured during a call, including at least human speech signals obtained via an acoustic input device.

The term “acoustic data” refers to digital data obtained by converting acoustic information into a machine-processable format with predetermined sampling conditions and encoding, and excluding fields that directly store personally identifiable information.

The term “secure communication path” refers to a communication channel between a terminal and a server that employs encryption and integrity protection mechanisms to prevent unauthorized access, interception, or tampering with transmitted data.

The term “information processing apparatus” refers to a computing apparatus including at least one processor, memory, and storage, configured to execute programs for analysis, storage, and generation of data.

The term “acoustic analysis program” refers to software executed by a processor to process acoustic data and to calculate acoustic feature quantities and characteristic quantities related to speech, such as pitch and speaking rate.

The term “external acoustic analysis service” refers to a function provided by an external computing resource, accessible via a communication network, that receives acoustic data and returns analysis results including acoustic feature quantities or related information.

The term “acoustic feature quantities” refers to numerical or categorical values representing properties of speech, including at least pitch, speaking rate, intonation, intensity, and pausing pattern, calculated from acoustic data.

The term “characteristic quantities indicative of a speaking tone” refers to one or more values derived from acoustic feature quantities that represent qualitative aspects of how a person speaks, such as calmness, excitement, or emphasis patterns.

The term “non-personal acoustic feature data” refers to structured data including acoustic feature quantities and characteristic quantities from which information capable of directly identifying an individual has been removed or obfuscated.

The term “information management mechanism” refers to a data management component, such as a database system or data store, which stores, indexes, and provides access to structured data including identifiers and time information.

The term “document data” refers to text data or structured textual content that can be processed by a document analysis program to extract writing-related features.

The term “document analysis program” refers to software executed by a processor to analyze document data and to calculate document feature quantities, including writing style, vocabulary selection, and syntactic structure.

The term “document feature quantities” refers to numerical or categorical values that represent properties of document data, including at least stylistic patterns, preferred vocabulary, and syntactic configurations.

The term “non-personal document feature data” refers to structured data including document feature quantities from which information capable of directly identifying an individual author has been removed or obfuscated.

The term “image data” refers to digital data representing still or moving images, including at least images in which a person's appearance is depicted.

The term “image analysis program” refers to software executed by a processor to analyze image data and to extract appearance feature quantities of one or more persons.

The term “appearance feature quantities” refers to numerical or categorical values representing visual characteristics of a person, such as body shape, posture, and clothing style, that are used for generating a virtual person and that omit direct biometric identifiers where required by privacy constraints.

The term “virtual person generation data” refers to data defining at least the appearance and behavior of a virtual person, including parameters for rendering, animation, and interaction, based on appearance feature quantities, non-personal acoustic feature data, and non-personal document feature data.

The term “virtual person” refers to a computer-generated character that visually resembles a human or humanoid figure and can exhibit behavior such as speech, gestures, and facial expressions.

The term “prompt sentence” refers to a text string or structured natural language instruction that is supplied as input to a generative AI model to cause the model to generate document data or other output.

The term “generative AI model” refers to a trained computational model that receives input including at least a prompt sentence and produces generated content, such as text or control information, based on learned patterns.

The term “generated document data” refers to text or textual content produced by a generative AI model in response to a prompt sentence and reflecting at least a part of associated document feature quantities.

The term “speech synthesis program” refers to software executed by a processor to generate synthetic speech waveforms based on text and control parameters including at least pitch and speaking rate.

The term “external speech synthesis service” refers to a speech synthesis function provided by an external computing resource, accessible via a communication network, that receives text and control parameters and returns synthetic speech data.

The term “generated speech control information” refers to parameters or control signals produced by a generative AI model or related processing, which configure a speech synthesis program or external speech synthesis service to generate speech with a desired style or tone.

The term “identifier” refers to a value, such as a session ID or pseudo-anonymous ID, that uniquely or quasi-uniquely distinguishes records or sessions within the information management mechanism without directly revealing a real-world identity.

The term “time information” refers to data indicating at least one of a time point or a time interval associated with acquisition, analysis, or generation of data in the system.

The term “terminal” refers to a user-operated device including at least an acoustic input/output device and a communication control device, capable of participating in calls and transmitting data to the server.

The term “call” refers to a real-time communication session in which two or more parties exchange information via audio, and optionally additional modalities, over a communication network.

In one embodiment, a server cooperates with at least one terminal operated by a user to implement the claimed system. The server includes at least one processor, a main memory, and a non-volatile storage device, and executes an operating system such as a general-purpose server operating system. The terminal includes an acoustic input/output device such as a built-in microphone and loudspeaker or a wired or wireless headset, and a communication control device such as a network interface controller. The terminal executes a communication application such as a voice or video conferencing application that allows the user to participate in calls over a packet-switched network.

The terminal uses its acoustic input/output device and an audio subsystem of an operating system, such as an audio framework of a mobile or desktop platform, to capture analog voice signals of the user during a call and convert the analog signals into digital acoustic information. The terminal performs analog-to-digital conversion, for example at a sampling frequency such as 16 kHz or 48 kHz, and produces linear pulse code modulation audio frames. The terminal optionally encodes the audio frames with an audio codec, such as a waveform or transform codec, and associates each frame with metadata including a session identifier and timestamp generated by the terminal.

The terminal uses its communication control device and a communication stack, such as a transmission control protocol and transport layer security protocol, to transmit the acoustic information to the server via a secure communication path. The terminal encapsulates the acoustic information into application-level messages, such as requests to a representational state transfer interface exposed by the server, and includes in each message an anonymized session identifier that does not contain personally identifiable information. The terminal can buffer audio frames in local memory and perform retransmission if packet loss or network congestion is detected by the communication stack.

The server receives the acoustic information from the terminal via the secure communication path and stores the received data in the storage device as acoustic data in a format that excludes personally identifiable information. The server uses a web application framework, such as a server-side framework running on the processor, to parse the received messages and extract audio payloads and associated metadata. The server removes any headers or fields that might include user names, device identifiers, or network addresses, and replaces them with internally generated identifiers. The server stores the sanitized audio payloads in a file store or an object store in association with the internal identifiers and timestamps.

The server executes an acoustic analysis program on the processor to process the acoustic data. The acoustic analysis program may be implemented as a set of modules, including a pre-processing module, a feature extraction module, and a tone characterization module. The pre-processing module normalizes amplitude levels to reduce dynamic range variation and applies band-pass filters to remove noise outside the typical speech frequency band. The feature extraction module computes acoustic feature quantities such as fundamental frequency, spectral envelope descriptors, energy per frame, zero-crossing rate, and phoneme duration estimates. The feature extraction module can use digital signal processing algorithms, such as autocorrelation-based pitch detection, Mel-frequency cepstral coefficient extraction, and short-time Fourier transforms, to compute the feature quantities.

The server optionally uses an external acoustic analysis service in addition to or instead of local processing. The server sends segments of acoustic data to the external service over a secure application programming interface, and the external service returns analysis results including time-aligned phonetic labels, word boundaries, and prosodic scores. The server combines the locally computed acoustic feature quantities with the externally returned analysis results to construct a higher-dimensional feature vector for each time segment.

The server uses the tone characterization module to derive characteristic quantities indicative of a speaking tone from the acoustic feature quantities. The tone characterization module applies statistical aggregation and pattern recognition techniques to sequences of frame-level features to estimate attributes such as average speaking rate, variability of pitch, relative durations of pauses, and energy modulation. The server may implement this module using a neural network classifier that maps sequences of feature vectors to tone categories such as calm, excited, or neutral. The neural network classifier can be configured as a recurrent or temporal convolutional architecture, trained offline using supervised learning with labeled tone categories. During training, the server minimizes a loss function, such as a cross-entropy function between predicted tone category distributions and ground-truth labels, and updates network parameters using a gradient-based optimizer. The server can perform regularization and data augmentation, such as temporal stretching and pitch shifting, on training data to improve robustness and reduce overfitting.

The server structures the resulting characteristic quantities as non-personal acoustic feature data. The server defines a data structure, such as a record or document, that includes fields for an internal identifier, time interval, aggregated acoustic feature quantities, tone category scores, and quality metrics such as confidence values. The server omits any free-form textual transcripts or speaker identifiers from this structure. The server stores the non-personal acoustic feature data in an information management mechanism such as a database management system. The server configures schemas, indexes, and partitioning strategies so that queries based on identifier or time range can be executed with low latency. This structured representation allows the server to reuse acoustic behavior patterns without reprocessing the original acoustic data, thereby reducing computational load and storage of sensitive data.

The server applies a document analysis program to document data associated with the user, such as messages or notes generated by the user in connection with calls. The document analysis program can be implemented as a text processing pipeline executed by the processor. The server tokenizes the document data, computes frequency distributions of terms, collocations, and part-of-speech tags, and generates document feature quantities representing writing style. The server may also extract syntactic parse trees and compute statistics about sentence length, clause structure, and use of functional words. The server encodes these document feature quantities as non-personal document feature data, using a similar structured data representation as for the acoustic features, and stores them in the same information management mechanism. The server excludes original text or named entities that could directly identify the user and stores only abstracted feature vectors and counts.

The server processes image data that includes past images of the user by executing an image analysis program on the processor. The server performs operations such as face and body detection, segmentation, and keypoint detection to identify human regions. The server extracts appearance feature quantities, such as proportions of body segments, general hairstyle shape descriptors, and typical clothing silhouettes. The server can use a neural network model, such as a convolutional network trained for pose estimation and style classification, to map images to appearance feature vectors. The server discards or obfuscates high-resolution facial textures or biometric signatures to maintain privacy. The server aggregates appearance feature quantities into a representation used to generate virtual person generation data.

The server generates virtual person generation data that defines at least appearance and behavior of a virtual person. The server integrates appearance feature quantities with non-personal acoustic feature data and non-personal document feature data by mapping each to respective sub-modules of a virtual person model. The server defines, for example, a body parameter set, a voice parameter set, and a language style parameter set, and stores these parameters in a data structure used by a rendering engine and a speech synthesis subsystem. The server can map average pitch and speaking rate to baseline voice parameters, map tone category probabilities to prosody control paths, and map document style features to language templates used when the virtual person “speaks” generated content.

The server generates a prompt sentence for a generative AI model by using the non-personal document feature data. The server executes a prompt generation module that constructs natural language descriptions of style constraints based on document feature quantities. For example, if the document analysis program determines that the user typically writes short sentences with neutral sentiment and low lexical diversity, the prompt generation module can produce a prompt sentence such as “Generate text in a concise, neutral tone with short sentences and limited vocabulary variation, without including any personal information.” The server supplies the prompt sentence to the generative AI model via an application programming interface.

The server can implement the generative AI model locally or access it as an external service. In one embodiment, the generative AI model is a neural network architecture that includes an embedding layer, multiple attention-based transformer blocks, and an output layer predicting token probabilities. The server uses pre-trained model parameters obtained from large-scale training on public corpora and optionally fine-tunes the model on anonymized style examples. During inference, the server encodes the prompt sentence into embeddings, propagates them through the transformer layers using learned attention weights, and decodes the resulting hidden states into generated document data. The server can control temperature, top-k sampling, or nucleus sampling parameters to adjust diversity and determinism.

The server uses the generated document data in association with the virtual person generation data. The server supplies the generated document data to a speech synthesis program or an external speech synthesis service together with the voice parameter set derived from the non-personal acoustic feature data. The speech synthesis program may be implemented as a neural vocoder pipeline, where the server first converts text to phoneme sequences using a grapheme-to-phoneme model, then predicts prosodic contours aligned with the tone characterization, and finally generates a waveform using a neural waveform generator such as an autoregressive or flow-based model. The server sets control parameters such as baseline pitch, speaking rate, and emphasis pattern thresholds according to the non-personal acoustic feature data so that the synthesized voice reflects the user's speaking style without replicating the exact voice timbre. The terminal plays back the synthesized audio through the acoustic output device, thereby providing the user with a pseudo-dialogue experience.

The server can also control a virtual person rendering engine that animates a virtual character on a display device. The server maps acoustic features and text timing to lip movements and facial expressions, for example by using a blendshape animation system or a skeletal animation system. The server uses appearance feature quantities to select and morph a base mesh of the virtual character into a body type and clothing style derived from non-personal visual characteristics. This mapping is executed by the processor using a graphics pipeline and associated shaders. By driving both voice and visuals from unified non-personal feature data, the server ensures temporal and stylistic coherence of the virtual person's behavior.

The user can request specific operations via the terminal by transmitting prompt sentences to the server. For example, the user can enter or select instructions such as “Analyze the voice from my last call and generate a short description of my general tone and speaking speed,” “Using the anonymized voice features from my last session, generate a description of my typical speaking style without including any personal information,” “Take the speaking rate and pitch profile stored for my calls and generate a sample monologue for a virtual assistant that sounds similar in style,” or “Using only non-personal voice characteristics in the database, configure a text-to-speech output that imitates my general tone but not my exact voice.” The server interprets such prompt sentences and maps them to internal operations, including retrieval of specific feature records from the information management mechanism and configuration of analysis or generation modules.

The server, by using structured non-personal feature data and system-generated prompt sentences, improves computer technology in several ways. First, the server reduces storage and communication overhead by discarding raw audio, full transcripts, and high-resolution images once relevant features are extracted, thereby lowering memory footprint and network usage. Second, the server achieves improved processing speed, because the server can repeatedly reuse stored feature vectors in downstream operations without re-analyzing original data. Third, the server improves accuracy and consistency of style reproduction by defining explicit data structures for acoustic feature quantities, document feature quantities, and appearance feature quantities, and by training specialized neural modules that operate directly on these structures.

The server implements non-conventional processing flows that differ from human manual workflows. For example, the server automatically converts statistical document features into machine-generated prompt sentences that contain explicit style constraints, ensuring that the generative AI model is guided by quantized and normalized style descriptors rather than subjective human instructions. The server uses internal rules and mappings to construct these prompts, such as thresholds on sentence length distributions and vocabulary diversity indices, which a human user would not ordinarily compute. The server also uses the same non-personal feature data to control multiple downstream components—generative AI, speech synthesis, and avatar animation—through unified parameterization, which yields a consistent temporal alignment and reduces synchronization errors.

The server improves data management by using the information management mechanism to index feature records by anonymized identifiers and temporal segments. The server can execute range queries, aggregation queries, and feature similarity queries to identify sessions with similar speaking styles or text styles, using vector similarity metrics. This allows the system to reuse representative feature sets for multiple generative tasks, thereby reducing redundant data and computation. Because the feature data is non-personal and compact, the server can retain a longer history of behavioral patterns while maintaining compliance with privacy policies.

The server can employ alternative architectures and algorithms in different embodiments. In one embodiment, the acoustic analysis program is entirely local, and the server uses a stack of convolutional and recurrent layers to derive tone representations directly from waveform segments, trained using a margin-based loss function that encourages separation between tone categories in an embedding space. In another embodiment, the document analysis program uses a transformer-based encoder trained to predict style labels from documents, and the internal embeddings from this encoder are stored as document feature quantities. In still another embodiment, the image analysis program uses a generative adversarial framework in which a generator reconstructs anonymized appearance representations while a discriminator enforces removal of identifiable features.

The terminal can vary as well. In one embodiment, the terminal is a handheld device, and in another embodiment, the terminal is a fixed kiosk with an integrated display and camera. The server can be deployed as a cluster of machines with distributed databases and load-balanced application servers, allowing horizontal scaling of analysis and generation workloads. The system can incorporate additional modalities, such as motion sensor data, mapped into extended feature vectors and integrated into the virtual person generation data.

By organizing processing around non-personal feature data, prompt sentence generation, and unified control of generative and synthesis modules, the server implements a specific improvement in the functioning of the computer system. The server transforms unstructured multimodal input into structured, reusable, and privacy-preserving representations that enable efficient, consistent, and technically robust generation of content and virtual behaviors, rather than merely automating a human conceptual task.

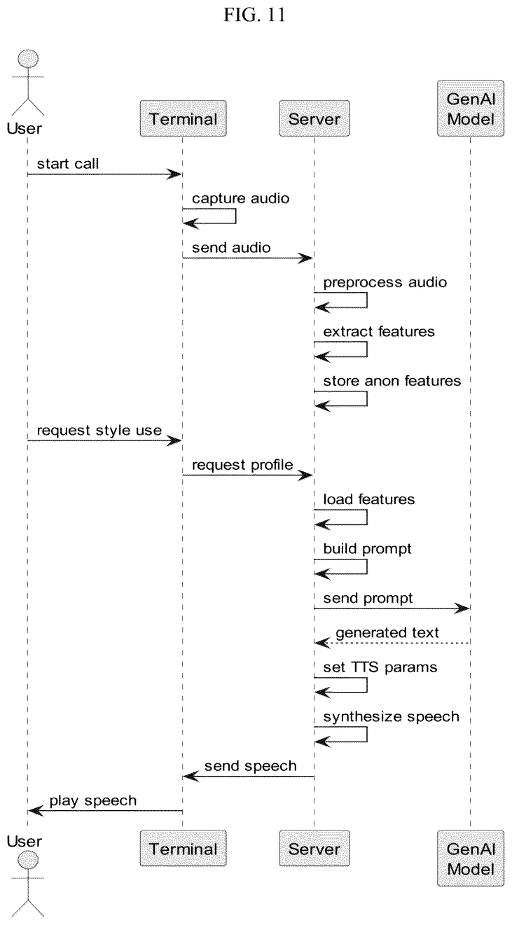

The following describes the processing flow using FIG. 11.

### Step 1

The user initiates a call on the terminal using a communication application.

The terminal activates an acoustic input/output device, such as a built-in microphone or headset, through an audio driver of the operating system.

The terminal receives an analog voice signal from the user and performs analog-to-digital conversion at a predefined sampling rate and bit depth.

Input: Analog speech waveform from the user's microphone.

Output: Digital audio frames representing the user's speech.

The terminal segments the digital audio stream into fixed-length frames (for example, 20-40 ms) and stores the frames in a buffer for further processing.

### Step 2

The terminal associates metadata with each audio frame.

The terminal generates or receives from the server an anonymized session identifier and obtains a timestamp from a system clock.

The terminal attaches the anonymized session identifier and timestamp to each buffered audio frame as metadata.

Input: Digital audio frames without metadata; session identifier; timestamp.

Output: Audio frames with associated anonymized session identifier and timestamp metadata.

The terminal thereby prepares audio packets that can be uniquely associated with a session without including personally identifiable information.

### Step 3

The terminal establishes a secure communication path to the server.

The terminal uses a communication control device and a network protocol stack to initiate a connection secured by a transport layer security protocol.

The terminal authenticates itself to the server using a token, key, or credential configured for the application.

Input: Audio frames with metadata; authentication credentials.

Output: An authenticated, encrypted connection between the terminal and the server.

The terminal confirms that the secure communication path is active before transmitting any audio data.

### Step 4

The terminal transmits the audio frames to the server.

The terminal encapsulates one or more audio frames and the associated metadata into a message conforming to a defined application-level protocol, such as a request to a server application interface.

The terminal sends the message over the secure communication path, monitors acknowledgments, and retransmits if packet loss or timeout occurs.

Input: Buffered audio frames with metadata; active secure connection.

Output: Messages containing audio data and metadata delivered to the server.

The terminal may apply compression or codec-level encoding to reduce bandwidth before transmission.

### Step 5

The server receives the messages containing audio data.

The server's network interface and server application framework accept incoming messages, verify authentication information, and decrypt the message payloads.

The server parses the protocol headers and extracts the audio frames and associated metadata, including the anonymized session identifier and timestamp.

Input: Encrypted messages containing audio data and metadata.

Output: Decrypted audio frames and metadata available in server memory.

The server stores the extracted audio frames in a temporary buffer or file store for pre-processing.

### Step 6

The server pre-processes the acoustic data.

The server reads audio frames from the temporary buffer and applies digital signal processing operations such as normalization, noise reduction, and band-pass filtering.

The server converts the audio into a uniform internal format (for example, mono, 16 kHz, linear pulse code modulation) suitable for downstream analysis.

Input: Raw digital audio frames with metadata.

Output: Normalized, filtered, format-converted audio segments with preserved session identifier and timestamps.

The server aggregates frames into analysis segments, such as 10-30 second windows, and discards any extraneous metadata that may contain identifying information.

### Step 7

The server extracts low-level acoustic features.

The server applies an acoustic analysis program to the pre-processed audio segments to compute frame-level features such as fundamental frequency, energy, zero-crossing rate, and spectral coefficients.

The server executes algorithms such as short-time Fourier transform, Mel-frequency cepstral coefficient extraction, and autocorrelation-based pitch detection to derive these features.

Input: Pre-processed audio segments with session metadata.

Output: Sequences of frame-level acoustic feature vectors associated with the session identifier and time indices.

The server stores the feature sequences in memory for higher-level tone analysis.

### Step 8

The server optionally uses an external acoustic analysis service.

The server sends selected audio segments to an external analysis endpoint via a secure application programming interface, including configuration parameters such as language and sampling rate.

The server receives responses containing information such as phonetic labels, word timings, and prosodic scores.

Input: Pre-processed audio segments; configuration parameters.

Output: External analysis results including aligned phonetic and prosodic information.

The server merges these external results with the locally computed feature vectors by time alignment, creating enriched feature sequences.

### Step 9

The server computes speaking tone and aggregated acoustic feature quantities.

The server applies a tone characterization module, which may include a neural network classifier, to the enriched feature sequences.

The server feeds sequences of feature vectors into the classifier, obtains probabilities or scores for tone categories (for example, calm, excited, neutral), and computes aggregated statistics such as average pitch, pitch range, speaking rate, pause ratio, and energy variability.

Input: Sequences of enriched frame-level acoustic features.

Output: Aggregated acoustic feature quantities and tone characteristic quantities per segment and per session.

The server uses mathematical operations including averaging, variance computation, and histogram analysis to produce these aggregated values.

### Step 10

The server structures non-personal acoustic feature data.

The server constructs a data record or document for each analysis unit, including fields for anonymized session identifier, time interval, aggregated acoustic feature quantities, tone category scores, and quality metrics.

The server omits or removes any text transcripts, raw audio references, or identifiers that could allow direct personal identification.

Input: Aggregated acoustic feature quantities; tone characteristic quantities; session identifier; time interval information.

Output: Structured non-personal acoustic feature data records.

The server stores these records in a designated collection or table within an information management mechanism.

### Step 11

The server analyzes document data to produce non-personal document feature data.

The server retrieves document data associated with the same or related sessions, such as user-generated text or call-related notes, from storage.

The server applies a document analysis program to tokenize the text, tag parts of speech, parse syntax, and compute statistics such as sentence length distribution, vocabulary frequency, and use of function words.

Input: Raw text documents associated with anonymized identifiers.

Output: Document feature quantities such as style vectors, syntactic pattern statistics, and vocabulary usage profiles.

The server structures these quantities into non-personal document feature data records that exclude original text and named entities, and stores them in the information management mechanism.

### Step 12

The server analyzes image data to produce appearance feature quantities.

The server retrieves image data associated with the user, such as past photographs or video frames, and executes an image analysis program.

The server performs detection of human regions, extraction of body keypoints, and computation of shape and clothing descriptors, using, for example, convolutional neural network models trained for pose estimation and style analysis.

Input: Image data with anonymized identifiers.

Output: Appearance feature quantities describing general body proportions, posture patterns, and clothing silhouettes without storing exact biometric textures.

The server aggregates appearance features into a compact representation per user or per profile and stores them in the information management mechanism.

### Step 13

The server generates virtual person generation data by integrating multiple feature types.

The server retrieves non-personal acoustic feature data, non-personal document feature data, and appearance feature quantities that correspond to a given anonymized profile or session.

The server maps these data to parameter sets for appearance, voice, and language style, defining fields such as body shape parameters, base pitch, speaking rate, tone weights, and stylistic constraints for generated text.

Input: Non-personal acoustic feature data; non-personal document feature data; appearance feature quantities.

Output: Virtual person generation data specifying appearance parameters and behavior parameters for a virtual person.

The server stores the virtual person generation data in a format compatible with a rendering engine and speech synthesis subsystem.

### Step 14

The server generates a prompt sentence for a generative AI model based on document feature data.

The server analyzes the non-personal document feature data to identify characteristic patterns, such as preference for short sentences, neutral sentiment, or particular syntactic constructions.

The server converts these quantified characteristics into a natural language description that specifies style constraints, thereby forming a prompt sentence.

Input: Non-personal document feature data associated with a profile or session.

Output: A prompt sentence describing desired text style for the generative AI model.

The server may, for example, output a prompt like: “Generate text in a concise, neutral tone with short sentences and limited vocabulary variation, without including any personal information.”

### Step 15

The server interacts with a generative AI model using the prompt sentence.

The server sends the generated prompt sentence to a generative AI model interface, optionally including additional structured context such as target length or topic constraints.

The server receives generated document data from the generative AI model, which reflects the stylistic constraints encoded in the prompt sentence.

Input: Prompt sentence; optional control parameters.

Output: Generated document data produced by the generative AI model.

The server stores or forwards the generated document data in association with the corresponding virtual person generation data.

### Step 16

The server configures a speech synthesis program or external speech synthesis service.

The server retrieves non-personal acoustic feature data that includes aggregated quantities such as base pitch, speaking rate, and prosodic pattern descriptors for the profile.

The server sets control parameters of the speech synthesis program or service, including target pitch contour, syllable timing, pause durations, and intensity scaling, according to these feature quantities.

Input: Non-personal acoustic feature data; generated document data.

Output: Control parameter set for speech synthesis aligned with the desired speaking tone and voice characteristics.

The server then supplies the generated document data and control parameter set to the speech synthesis program or service for waveform generation.

### Step 17

The server produces synthetic speech and virtual person behavior.

The server obtains synthesized speech waveforms from the speech synthesis program or external service, which has been controlled using the non-personal acoustic feature data.

The server optionally computes timing information from the synthesized audio, such as phoneme or word alignment, and maps this timing to animation parameters for a virtual person, including lip movement and facial expression changes.

Input: Control parameters for speech synthesis; generated document data; virtual person generation data.

Output: Synthetic speech audio and synchronized behavior parameters for a virtual person.

The server packages these outputs as a media stream or control message for delivery to the terminal.

### Step 18

The terminal presents the generated content and behavior to the user.

The terminal receives synthetic speech and, if applicable, avatar control parameters from the server over the secure communication path.

The terminal plays the synthetic speech through its acoustic output device and renders the virtual person on a display device, applying the received animation parameters to drive lip-sync and gestures.

Input: Synthetic speech data; virtual person behavior parameters.

Output: Audio-visual presentation that allows the user to experience a pseudo-dialogue or interaction with the virtual person.

The user can then provide further input or new instructions, which can include additional prompt sentences for further operation of the generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content recommendation and avatar-generation techniques mainly rely on explicit user profiles, historical interaction logs, or simple text-based analysis. Such techniques suffer from several technical limitations when applied to real-time communication environments, such as voice calls conducted over communication networks. First, existing systems do not efficiently exploit low-level acoustic features of a user's voice, such as vocal characteristics and speaking tone, in a manner that both preserves privacy and provides a meaningful basis for personalization. As a result, networked servers often must either transmit and store large volumes of raw audio data, increasing bandwidth and storage load, or discard such data entirely, thereby losing potentially rich signals about the user's state and preferences.

Second, typical server-side architectures are not designed to transform abstract, non-identifying voice feature data into structured inputs for a generative AI model in a consistent and machine-optimizable way. In many cases, ad hoc prompt construction leads to unstable output quality, poor interpretability, and difficulty in scaling the system to multiple content domains or device types. The lack of a standardized pipeline from real-time acoustic analysis to prompt sentence generation reduces the effectiveness and reliability of generative AI models in content recommendation scenarios.

Third, known systems treat voice-based personalization, text-based personalization, and avatar (virtual person) generation as separate functions. This fragmentation prevents an integrated representation of a user across modalities (audio, text, and image), which in turn limits the accuracy and continuity of the user experience. For example, a system may generate a virtual persona from images but fail to align that persona with the user's conversational style or emotional tone, resulting in an inconsistent communication interface.

Fourth, privacy constraints impose additional technical challenges. In order to comply with privacy and data protection requirements, systems must avoid storing personally identifying raw audio or text content. However, naive anonymization approaches often discard too much information, yielding feature sets that are no longer useful for meaningful personalization, or rely on brittle heuristics that do not scale well across different devices, network conditions, or communication applications.

Therefore, there is a need for a computer-implemented technique that: (i) efficiently acquires and processes voice data during calls to extract non-identifying yet expressive feature information; (ii) systematically converts such feature information into semantically rich prompt sentences suitable for use with a generative AI model; (iii) integrates voice-based features, text-based “speaker-likeness,” and virtual person information derived from image data into a unified representation; and (iv) uses this unified representation to provide improved, personalized communication and content recommendation experiences, while reducing bandwidth, improving server-side processing efficiency, and preserving user privacy. The present invention addresses these technical problems by improving the way a server processes, transforms, and uses multi-modal user data in a distributed computing environment.

The specific processing by the specific processing unit 290 of the data processing device 12 in Application Example 1 is realized by the following means.

The present invention provides a server comprising a processor and a memory storing instructions that, when executed by the processor, cause the processor to acquire, via an audio input/output interface, audio signals during a call, convert the audio signals into digital audio information, extract feature information indicative of vocal characteristics and speaking tone of a speaker from the digital audio information, and generate, from the feature information, derived information that excludes personal identification information; to generate, based on the feature information, semantic information corresponding to the vocal characteristics and the speaking tone of the speaker and to construct a prompt sentence including the semantic information for instructing a generative AI model to perform content recommendation; to input the prompt sentence into the generative AI model to obtain generated text information, to select, based on the generated text information, a group of candidate audio content items from a content data store, and to output recommendation information including the group of candidate audio content items so as to be presentable at a terminal device; and to associate and store, as storage information, the feature information relating to the vocal characteristics and the speaking tone acquired from the call, feature information indicating speaker-likeness extracted from text information, and virtual person information generated from image information, and to provide, on the basis of the storage information, a personalized communication experience and content presentation experience by integrally using the vocal characteristics and speaking tone of the speaker, the speaker-likeness in text, and the virtual person information. This enables the server to implement an improved computer-implemented pipeline that reduces transmission and storage of raw audio data, maintains user privacy by operating on non-identifying feature representations, systematically generates stable and semantically rich prompt sentences for the generative AI model, and delivers an integrated, multi-modal personalization framework that enhances recommendation accuracy and user experience while improving processing efficiency in network-based communication systems.

The term “audio signal” refers to an analog or digital representation of sound waves produced by a speaker during a call, including variations in air pressure that can be captured and processed by audio hardware and software.

The term “audio input/output device” refers to a hardware and software combination, such as a microphone, speaker, and associated driver or interface, that enables acquisition, conversion, and reproduction of audio signals in a computing system.

The term “digital audio information” refers to audio data that has been converted from an analog audio signal into a discrete, machine-readable numerical representation, such as pulse-code modulation samples or encoded audio frames.

The term “feature information” refers to numerical or symbolic data extracted from raw input data, such as digital audio information or text, which quantitatively or qualitatively describes characteristics including, but not limited to, vocal properties, speaking tone, or stylistic attributes.

The term “vocal characteristics” refers to properties of a speaker's voice, including, for example, pitch, loudness, timbre, spectral envelope, and speaking rate, which can be derived from an audio signal by signal processing or machine learning techniques.

The term “speaking tone” refers to prosodic and paralinguistic aspects of speech, such as intonation, stress, rhythm, and emotional nuance, that convey attitude or affect beyond the literal lexical content.

The term “derived information” refers to secondary data generated from original input data, such as audio or text, through processing or transformation, where the resulting data does not directly contain personal identifiers but preserves characteristics useful for analysis or personalization.

The term “personal identification information” refers to information that alone or in combination with other information can be used to identify a specific individual, such as a name, an address, a direct voiceprint, or raw biometric patterns.

The term “semantic information” refers to structured or unstructured data that expresses the meaning or interpretation of feature information, including labels, descriptions, or classifications that can be understood and further processed by humans or machines.

The term “prompt sentence” refers to a text sequence that encodes instructions, conditions, or context and is provided as input to a generative AI model to control or guide the content and format of the model's output.

The term “generative AI model” refers to a computational model, such as a machine learning or neural network model, that is configured to generate new data instances, including text, audio, images, or other content, in response to input conditions such as prompt sentences.

The term “content recommendation” refers to a process of selecting one or more content items from a content collection on the basis of input criteria, such as user-related feature information or semantic information, for presentation to a user.

The term “text information” refers to data expressed in a character-based or token-based linguistic form, including sentences, paragraphs, or structured text that can be processed, analyzed, or generated by a computing system.

The term “audio information content” refers to content items whose primary modality is audio, such as music tracks, spoken-word recordings, podcasts, or other forms of sound-based media.

The term “candidate audio information contents” refers to one or more audio information content items that are selected as potential recommendations before final presentation or ranking for a user.

The term “recommendation information” refers to data indicating one or more recommended content items, including identifiers, metadata, and optionally ranking or grouping information, that is formatted for presentation to a user via a terminal device.

The term “terminal device” refers to an endpoint computing apparatus, such as a smartphone, tablet, personal computer, or wearable device, that communicates with a server and provides an interface for input and output to a user.

The term “storage information” refers to data stored in a memory device or storage medium, including feature information, semantic information, associations, and identifiers, used for later retrieval and processing in the system.

The term “speaker-likeness” refers to characteristics of content, particularly text, that resemble or reflect a specific speaker's style, tone, or habitual patterns of expression, without necessarily including personally identifying information.

The term “virtual person information” refers to data representing a computer-generated or synthesized persona, such as an avatar or digital character, derived from source inputs including, for example, image information or style parameters.

The term “image information” refers to visual data, including still images or video frames, represented in a digital format and processable by an image processing or analysis component.

The term “personalized communication experience” refers to an interaction between a user and a system, or between users mediated by a system, in which the content, style, or behavior of the system is adapted based on user-specific feature information.

The term “content presentation experience” refers to a user's experience of viewing, selecting, and consuming content items that are displayed or played by a system in a particular order, format, or style.

The term “dialogue information” refers to data representing interactive or conversational content, including generated or recorded utterances and associated metadata, that can be used to simulate or support communication with a speaker or virtual person.

The term “server” refers to a computing apparatus, which may include one or more processors and memory units, configured to provide processing, storage, and communication services to one or more terminal devices over a network.

The term “processor” refers to a hardware execution unit, such as a central processing unit or a processing core, or a set of such units, configured to execute instructions and perform logical, arithmetic, and control operations within the system.

The term “memory” refers to any non-transitory computer-readable medium, such as volatile or non-volatile storage devices, configured to store instructions and data for access by a processor.

In one embodiment, a server, a terminal, and a communication network cooperate to implement the claimed system. The server includes at least one processor and at least one non-transitory memory storing executable instructions. The terminal includes an audio input/output device, such as a microphone and speaker integrated into a smartphone, tablet, or personal computer, and a local processor and memory. The user operates the terminal and participates in a call using a communication application. The server and the terminal are connected via a packet-based network, such as the Internet, using secure transport protocols.

The terminal acquires an audio signal produced by the user during a call via the audio input/output device. The terminal uses an operating system level audio interface, such as an audio recording interface of a mobile operating system or a desktop multimedia framework, to obtain the analog audio signal, to sample the analog audio signal at a predetermined sampling frequency, for example 16 kHz, and to convert the sampled signal into digital audio information represented as pulse-code modulation samples. The terminal stores the digital audio information in a ring buffer structure maintained in a random access memory. The ring buffer enables the terminal to maintain a sliding window of recent audio frames while discarding older data, thereby limiting memory usage and reducing the amount of raw audio that needs to be transmitted.

The terminal processes the digital audio information to derive feature information indicative of vocal characteristics and speaking tone of the user. The terminal applies a pre-processing module implemented using known audio processing libraries, such as a noise suppression library, an acoustic echo cancellation module, and a voice activity detection algorithm. The terminal divides the digital audio information into short frames, for example frames of 20 to 30 milliseconds with an overlap, and applies a window function to each frame. For each frame, the terminal computes a discrete Fourier transform and obtains a magnitude spectrum. On the basis of the magnitude spectrum, the terminal derives low-level acoustic features including short-time energy, zero-crossing rate, and mel-frequency cepstral coefficients. The terminal further estimates fundamental frequency and pitch contour using an autocorrelation-based method or a cepstrum-based method. The terminal aggregates the frame-level features across a fixed time window into statistical descriptors, such as a mean and variance of pitch, a mean and variance of frame energy, a distribution of speaking rate, and prosodic patterns of intonation changes.

The terminal converts the aggregated descriptors into feature information in a structured format, such as a key-value list, that includes items like average_pitch_hz, energy_variation, speaking_rate, tone_class, and timbre_class. The terminal executes a small classification model or rule set locally to assign categorical labels, such as “calm,” “energetic,” or “stressed,” to the speaking tone. The local classification model can be implemented as a lightweight neural network deployed using an embedded machine learning framework or as a rules-based engine that thresholds numerical features. The terminal discards the raw digital audio information after feature extraction and keeps only the derived feature information, thereby reducing the size of data that must be transmitted and reducing exposure of raw biometric voice data.

The server receives the feature information from the terminal via a secure communication protocol. The server validates the structure of the feature information and stores the feature information in a data storage layer, such as a relational database or a key-value store. The server associates the stored feature information with a session identifier that does not contain personal identification information. The server does not store the raw audio signal; instead, the server operates only on the extracted feature information, which is a compressed representation that is sufficient for personalization but insufficient to reconstruct the original voice waveform.

The server interprets the feature information to generate semantic information describing the vocal characteristics and speaking tone of the user. The server loads a feature-to-label mapping module implemented as a neural network classifier. The neural network classifier may be a feed-forward network with several dense layers and non-linear activation functions. The input layer receives the numeric feature vector, which includes pitch-related metrics, energy metrics, spectral features, and prosodic statistics. Hidden layers compute non-linear combinations of these values to classify the input into categories corresponding to emotional or tonal states, such as “relaxed,” “enthusiastic,” or “tense.” The output layer produces probabilities over a set of tone categories. The server selects the category with the highest probability, and also uses intermediate outputs, such as attention weights or layer activations, to generate refined semantic descriptors such as “gentle and relaxed” or “bright and energetic.”

The server converts the semantic descriptors into natural language fragments using a templating module. For example, if the classifier outputs “relaxed” with high confidence and indicates low speaking rate and low energy variation, the server constructs a descriptive phrase: “the user's voice quality is calm, and the speaking tone is gentle and relaxed.” By using the neural network classifier rather than simple thresholding, the server is able to capture complex, non-linear relationships between multiple acoustic features, which improves classification accuracy under various background noise and device conditions. This step produces a compact semantic representation that is more robust to noise than raw signal data and more informative than unstructured numerical features.

The server generates a prompt sentence for a generative AI model based on the semantic information. The server uses a prompt-construction module that concatenates fixed instruction segments with the semantic descriptors and additional constraints. The server, for example, constructs a prompt sentence such as:

“The user's voice quality is calm and the speaking tone is gentle and relaxed. Based on this profile, recommend several relaxing audio contents, such as meditation podcasts, soft ambient music, or calm storytelling, that are suitable for this user.”

In another example, when the feature information indicates high pitch variability and high energy, the server constructs a prompt sentence such as:

“The user's voice quality is bright, and the speaking tone is energetic and enthusiastic. Recommend several upbeat and motivational audio contents, such as energetic music playlists, inspirational podcasts, or workout audio guides, that match this profile.”

The server can further customize the prompt sentence to request machine-readable output from the generative AI model, by including instructions to return lists or tags in a structured textual format. The prompt sentence thus serves as a deterministic, machine-generated control input for the generative AI model that captures both the acoustic characterization of the user and the desired recommendation task.

The server applies a generative AI model to the prompt sentence. In one embodiment, the generative AI model is a transformer-based neural network trained on large corpora of text, including content descriptions and category labels. The server passes the prompt sentence as a sequence of tokens into the input of the transformer model. The transformer model includes multiple encoder-decoder blocks, self-attention mechanisms, and feed-forward layers. Each layer refines the internal representation by computing weighted combinations of token embeddings according to learned attention weights. The model generates output tokens sequentially, conditioned on the prompt sentence and the previously generated tokens.

The server configures the generative AI model with parameters such as maximum output length, temperature, and sampling strategy, for example top-k or nucleus sampling, to balance diversity and determinism of generated text. The server executes inference on specialized hardware, such as graphics processing units or tensor processing units, to reduce latency. The generative AI model outputs text information including recommended categories, content types, mood descriptors, and sometimes candidate titles or descriptions. The use of the transformer architecture, trained and tuned for this type of conditional language generation, enables the system to capture nuanced relationships between the prompt sentence and the content domain, and to generate a rich, contextually appropriate recommendation description that would not be feasible with simple template-based or rule-based systems.

The server parses the text information generated by the generative AI model. The server uses a parsing module that applies pattern matching, regular expressions, or rule-based segmenters to identify content categories, mood tags, and suggested content descriptors within the generated text. In some embodiments, the server instructs the generative AI model, via the prompt sentence, to output recommendations in a list format such as: “1. guided sleep meditation, 2. ocean wave soundscapes, 3. slow piano relaxation playlist.” The parser converts the list into internal data structures, such as arrays of recommendation candidates, each having fields for category, mood, and description.

The server maps the recommendation candidates to concrete audio content items stored in a content database or accessible via external content services. The server executes queries against the content database, searching for items whose metadata, such as genre, mood tag, duration, and language, match the categories and keywords returned by the generative AI model. The server uses an index structure, such as an inverted index or a vector similarity index, to efficiently locate relevant items and to rank them according to similarity scores or historical popularity. The server generates recommendation information that includes identifiers, titles, content types, descriptions, and access links or identifiers for each selected content item. The server also associates the recommendation information with the session identifier and stores the association for possible future refinement or analysis.

The server associates and stores, as storage information, multiple types of feature information. The storage information includes feature information relating to the vocal characteristics and speaking tone acquired from calls, feature information indicating speaker-likeness extracted from text information, and virtual person information generated from image information. The server may derive speaker-likeness features from a corpus of text attributed to the user by applying a text-style encoder model, which computes numerical vectors describing lexical choice, syntax patterns, and typical phraseology. The server may derive virtual person information from images by applying a convolutional neural network that generates a representation of facial features, posture, or style, which can be used to create an avatar model.

The server uses the stored information to provide a personalized communication experience and content presentation experience. When the user interacts with the system in future sessions, the server retrieves historical feature information and combines it with current feature information to refine the prompt sentence and recommendation choices. The server can generate dialogue information that mimics the user's speaking style and tone by instructing the generative AI model with prompt sentences that specify both the current tone classification and historical speaker-likeness features. For example, the server may generate dialogue content for a virtual companion that speaks in a style matching the user's past texts and in a tone suitable for the current emotional state, as inferred from the latest call.

The terminal receives the recommendation information from the server and presents the recommended audio content items to the user via a user interface. The terminal may display the recommended items in a list or grid format, with titles, descriptions, and artwork. The user selects an item, and the terminal uses a media playback component to stream and reproduce the associated audio. Because the server has already transformed raw audio into compact feature information and pre-selected a small set of suitable content items, the terminal can render the content list quickly and with minimal additional computation.

The system provides a technical improvement over conventional architectures by reducing the volume of raw data transmitted over the network, by operating on compressed feature information that is specifically structured for machine classification and generation, and by implementing a multi-stage pipeline that aligns voice-based features, text-based speaker-likeness, and image-based virtual person information. The combination of on-device feature extraction, server-based semantic interpretation, and structured prompt sentence construction results in lower latency and improved accuracy in personalization compared to systems that either transmit raw audio or rely solely on static user profiles.

The server improves computer technology itself in several ways. First, the transformation of raw audio into feature information at the terminal and the subsequent removal of personal identification information before transmission reduces network load and storage requirements, which is a measurable improvement in communication efficiency. Second, the use of a specialized neural network classifier to derive tone categories from high-dimensional acoustic features improves robustness and classification precision, thereby improving the reliability of the downstream generative AI model without requiring manual feature engineering for each new device or environment. Third, the deterministic construction of prompt sentences from semantic information provides a stable and optimizable interface between feature extraction and generative AI inference, which addresses a technical problem of unpredictable behavior in generative systems.

The generative AI model in the server operates under specific constraints defined by the prompt sentence and by the server-side parsing logic. The server does not simply replace human decision-making; instead, the server uses a transformer architecture trained with a loss function that minimizes divergence between predicted tokens and ground truth tokens in training data, and updates network weights via gradient descent. The server can further fine-tune the model on domain-specific datasets containing content descriptions and user feedback, thereby aligning the output distribution with technical goals such as recommendation relevance and diversity. The server may implement data augmentation strategies, such as random perturbation of prompt structures or synonyms, to increase robustness of the generative AI model to variations in input phrasing.

The system adopts non-conventional processing sequences that differ from simple automation of human tasks. For example, the server does not merely mirror a human expert who listens to audio and manually chooses content. Instead, the server uses a composed feature vector derived from acoustic signal processing, passes the vector through a neural classifier with learned non-linear decision boundaries, programmatically converts classifier outputs into controlled natural language prompts, and uses these prompts to steer a generative model with hundreds of millions or more parameters, followed by a machine-implemented mapping of abstract suggestions to actual content items using indexed search. This multi-stage, data-structure-driven pipeline is tailored to the capabilities and limitations of digital computing systems and yields faster and more consistent personalization decisions than could be achieved manually.

In alternative embodiments, the terminal may implement some or all of the neural classification locally, reducing the amount of feature information that needs to be transmitted.

In another variation, the server may adjust the complexity of the generative AI model or the prompt sentence depending on available computing resources or latency constraints, such as using a smaller model during peak load. In yet another embodiment, the server may apply different feature extraction techniques, such as recurrent neural networks or self-supervised embeddings, to derive voice representations that are especially robust to background noise or channel distortions.

The system can be applied not only to real-time call scenarios but also to asynchronous voice messages, video calls, or mixed-media communication sessions. In each case, the terminal acquires audio information, derives feature information in a consistent data structure, and transmits only non-identifying derived information to the server. The server then performs semantic interpretation, generates a prompt sentence for the generative AI model, and produces recommendation information or dialogue information that is tailored to the measured vocal characteristics and speaking tone of the user.

By structuring the flow of data and computation in this manner, the server and the terminal collectively realize a computer-implemented technique that improves processing efficiency, accuracy of personalization, and protection of user privacy, while enabling advanced generative AI-based content recommendation and communication experiences.

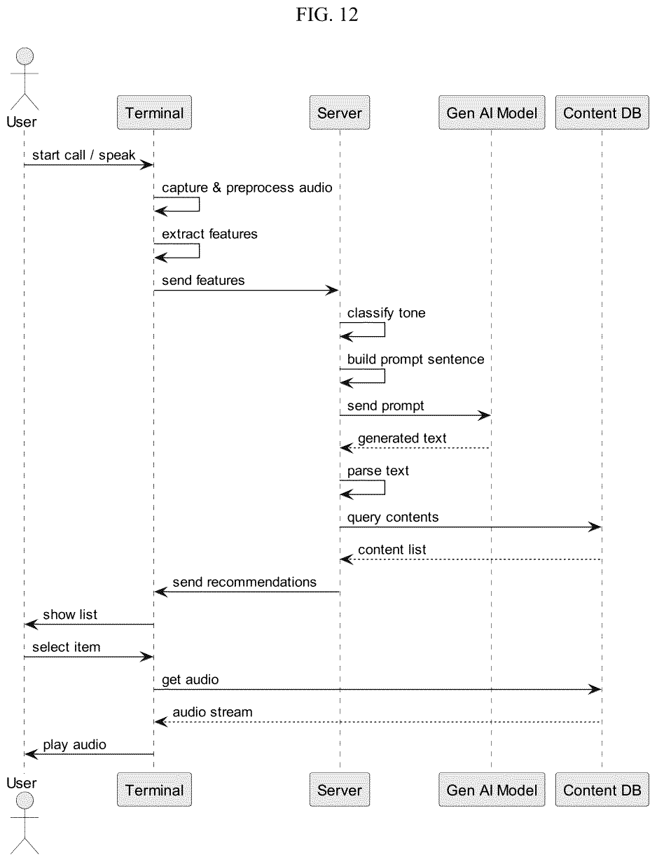

The following describes the processing flow using FIG. 12.

### Step 1

The user initiates a call using an application on the terminal.

The terminal uses its audio input/output device to capture the user's voice as an analog audio signal. The input of this step is the continuous analog audio produced by the user during the call. The terminal applies an operating system audio API to sample the analog audio at a fixed sampling rate (for example, 16 kHz) and to quantize the samples into digital audio information, such as 16-bit PCM frames. The output of this step is a sequence of digital audio frames stored temporarily in a ring buffer in the terminal's memory.

### Step 2

The terminal performs audio pre-processing on the digital audio frames. The input of this step is the sequence of digital audio frames obtained in Step 1. The terminal applies a noise suppression algorithm, echo cancellation, and automatic gain control using an audio processing library. The terminal then divides the audio into overlapping frames (for example, 20-30 ms per frame), applies a window function to each frame, and uses a voice activity detection algorithm to distinguish speech segments from silence or background noise. The terminal discards non-speech frames and retains only speech frames. The output of this step is a cleaned and segmented sequence of speech frames suitable for feature extraction.

### Step 3

The terminal extracts acoustic features from the speech frames. The input of this step is the pre-processed sequence of speech frames from Step 2. The terminal applies a discrete Fourier transform to each frame to obtain a magnitude spectrum, calculates mel-frequency cepstral coefficients, short-time energy, zero-crossing rate, and estimates fundamental frequency using an autocorrelation or cepstrum method. The terminal aggregates frame-level metrics over a defined time window by computing statistics such as mean pitch, pitch variance, mean energy, energy variance, speaking rate, and prosodic patterns of rising or falling intonation. The output of this step is a numerical feature vector representing the user's vocal characteristics and speaking tone.

### Step 4

The terminal classifies the speaking tone and constructs feature information. The input of this step is the numerical feature vector from Step 3. The terminal applies a lightweight classification model or rule set stored locally, which maps the feature vector to one of several tone categories such as “calm,” “energetic,” or “stressed.” The terminal then builds a structured feature object, for example a set of key-value pairs, including numerical fields (average_pitch_hz, energy_variation, speaking_rate) and categorical fields (tone_class, timbre_class). The terminal discards the raw digital audio frames after constructing this object, so only derived, non-identifying data remains. The output of this step is anonymized feature information describing the user's vocal characteristics and speaking tone.

### Step 5

The terminal transmits the anonymized feature information to the server. The input of this step is the structured feature information from Step 4 and a session identifier that does not contain personal identification information. The terminal serializes the feature information into a data format, such as JSON, and sends it to the server using a secure protocol, for example HTTPS. The terminal may batch multiple feature objects or send them periodically depending on system configuration. The output of this step is an encrypted network request containing the feature information delivered to the server.

### Step 6

The server receives and stores the feature information. The input of this step is the network request sent by the terminal in Step 5. The server's communication module accepts the request, verifies its integrity, and deserializes the JSON payload into an internal feature structure. The server checks that the payload contains only allowed fields and no personal identifiers. The server writes the feature structure into a data store, such as a relational database or key-value store, indexed by the session identifier. The output of this step is a persistent record of the vocal feature information stored on the server and ready for semantic interpretation.

### Step 7

The server interprets the feature information to create semantic descriptions. The input of this step is the stored feature structure retrieved from the data store. The server feeds the numeric portion of the feature vector into a neural network classifier configured to infer emotional or tonal categories. The classifier computes weighted sums and non-linear activations through several layers to generate probabilities for categories such as “relaxed,” “enthusiastic,” or “tense.” The server selects the category with the highest probability and may derive secondary attributes, such as “gentle,” “bright,” or “steady,” from internal activations. The server then constructs semantic phrases, for example “the user's voice quality is calm” or “the speaking tone is energetic and enthusiastic,” by mapping classifier outputs to text templates. The output of this step is semantic information describing the user's vocal characteristics and speaking tone in natural language form.

### Step 8

The server constructs a prompt sentence for a generative AI model. The input of this step is the semantic information from Step 7 and optional contextual parameters (such as content domain or language preference). The server uses a prompt-construction module to combine fixed instruction segments with the semantic phrases. The server generates, for example, a prompt sentence such as: “The user's voice quality is calm and the speaking tone is gentle and relaxed. Based on this profile, recommend several relaxing audio contents, such as meditation podcasts, soft ambient music, or calm storytelling, that are suitable for this user.” Alternatively, for an energetic tone, the server generates: “The user's voice quality is bright, and the speaking tone is energetic and enthusiastic. Recommend several upbeat and motivational audio contents, such as energetic music playlists, inspirational podcasts, or workout audio guides, that match this profile.” The output of this step is a fully formed prompt sentence tailored to the detected voice profile and the desired recommendation task.

### Step 9

The server invokes the generative AI model with the prompt sentence. The input of this step is the prompt sentence generated in Step 8. The server tokenizes the prompt sentence into a sequence of tokens and sends these tokens to a transformer-based generative AI model running on a server-side inference engine. The model processes the tokens through multiple attention and feed-forward layers, computing internal representations for each token. The model then generates output tokens sequentially, conditioned on the prompt sentence and previously generated tokens, until a stop condition is met. The server decodes these tokens back into human-readable text. The output of this step is generated text information that contains suggested categories, mood tags, and sometimes candidate titles or descriptions for audio content items.

### Step 10

The server parses the generated text information into structured recommendation candidates. The input of this step is the text output from the generative AI model obtained in Step 9. The server applies parsing rules, such as pattern matching for numbered lists or delimiter-based separation, to extract individual recommendation phrases. The server identifies, for each phrase, a content type (for example, “podcast,” “music playlist,” “guided meditation”), a mood or purpose (for example, “relaxation,” “motivation”), and optional descriptors. The server stores these as entries in an internal list structure, with fields for category, mood tag, and description. The output of this step is a set of structured recommendation candidates derived from the generative text.

### Step 11

The server maps the recommendation candidates to actual audio content items. The input of this step is the list of recommendation candidates from Step 10 and the metadata indexed in a content database. The server forms search queries using the candidate's category, mood tag, and keywords, and executes these queries against the content database or external content services. The server may use an inverted index, vector embeddings, or similarity scoring to retrieve and rank matching items. For each candidate, the server selects one or more concrete audio items, such as specific podcast episodes, music tracks, or playlists, that best match the candidate attributes. The output of this step is a list of concrete audio content items with associated metadata ready for recommendation.

### Step 12

The server packages the selected audio content items into recommendation information. The input of this step is the ranked list of concrete audio items from Step 11. The server builds a recommendation payload in a structured format, including for each item an identifier, title, content type, short description, mood label, artwork reference, and playback link or content ID. The server may sort items by relevance and limit the total number to a predetermined count. The server then serializes this payload, for example as JSON, and associates it with the current session identifier. The output of this step is a serialized recommendation information object ready for transmission to the terminal.

### Step 13

The server transmits the recommendation information to the terminal. The input of this step is the serialized recommendation payload from Step 12. The server sends the payload over the network as a response to an earlier request or as a push message using a communication protocol, such as HTTPS. The terminal receives the message and confirms successful receipt. The output of this step is the recommendation information delivered to the terminal and available to be rendered in the user interface.

### Step 14

The terminal presents the recommended content items to the user. The input of this step is the recommendation information received in Step 13. The terminal deserializes the payload and passes the list of items to a user interface layer. The terminal constructs interface elements, such as list entries or cards, displaying the title, description, and artwork for each recommended item. The terminal arranges the items according to the order specified by the server and renders them on the display. The output of this step is a visible list or grid of recommended audio content items accessible to the user.

### Step 15

The user selects a recommended item for playback. The input of this step is the displayed list or grid of recommended items from Step 14. The user reviews the recommendations, taps or clicks on a desired item, or opens a detail view to read more information. The user then activates a play control associated with the selected item. The output of this step is a user selection event identifying the chosen audio content item.

### Step 16

The terminal plays back the selected audio content item. The input of this step is the user selection event from Step 15 and the playback link or content ID included in the recommendation information. The terminal uses a media playback component to request the audio stream or file associated with the selected item from a content server. The terminal decodes the audio data and sends the decoded samples to the audio output device for reproduction. The user hears the audio content that has been recommended based on the vocal characteristics and speaking tone detected earlier. The output of this step is the actual audio playback experienced by the user, completing the end-to-end processing flow from call audio acquisition to personalized content consumption.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional human-like communication systems that utilize recorded messages, scripted templates, or generic language models suffer from several technical limitations. A conventional system typically treats user text data as unstructured content and does not construct a persistent, machine-interpretable profile of user-specific language behavior. As a result, when a language generation engine produces responses, the engine repeatedly processes raw historical text in an ad hoc manner or ignores most of the historical data, leading to inefficient use of computing resources and low reproducibility of a user's characteristic style.

Furthermore, conventional systems do not tightly integrate a structured analysis pipeline for multi-modal data, including voice information and image information, into the generation of personalized responses. In many cases, voice features such as voice quality and speaking tone are not extracted as reusable feature quantities, and image information is not converted into abstract appearance feature quantities that can be systematically linked with textual style information. This fragmentation of processing causes redundant computation, increased latency, and inconsistent behavior of the system across different communication modalities.

In addition, generic generative AI models are typically invoked with simple, manually crafted prompts that do not programmatically encode user-specific linguistic statistics. Such models treat every generation request as independent and do not benefit from a precomputed user language profile. Consequently, the models either require excessive context tokens, leading to higher computational load and response time, or fail to reproduce a stable “user-like” style, resulting in an artificial, system-like tone rather than an individualized one.

There is therefore a need for an improved computer-implemented system and server-side processing architecture that: (i) converts historical communication data into structured feature information, (ii) maintains a persistent user language profile and associated voice and appearance feature quantities in storage, and (iii) automatically composes rich, model-specific prompt information for a generative AI model based on the stored profile. Such a system should improve the efficiency, latency, and consistency of personalized text and voice generation, and provide a technically enhanced communication experience that is closer to real user behavior while reducing redundant analysis for each generation request.

The specific processing by the specific processing unit 290 of the data processing device 12 in Example 2 is realized by the following means.

The present invention provides a server comprising a processor and a memory, the processor being configured to receive, from a terminal, structured information including past character information, normalize the structured information by removing user identification information and associated metadata, and extract the character information; to execute, by using a natural language processing engine, segmentation and statistical analysis on the character information to generate language feature information including frequent expressions and style feature quantities; to store the language feature information in the memory as a user language profile that is indexed by a user identifier and is reusable across multiple generation requests; to receive, from the terminal, generation request information including a prompt sentence for a generative AI model; to generate, based on the user language profile, generation instruction information by programmatically adding style condition information and word-usage condition information to the prompt sentence; to input the generation instruction information into the generative AI model hosted locally or accessed via a model interface, and to obtain response character information that reflects the user language profile; to output the response character information to the terminal; to extract voice quality feature quantities and speaking-tone feature quantities from voice information acquired from calls and store the extracted voice feature quantities in association with the user language profile in the memory; and to analyze past image information to extract person appearance feature quantities, generate virtual person information based on the appearance feature quantities, and store the virtual person information in the memory in association with the user language profile and the voice feature quantities. This enables the server to transform heterogeneous historical communication data into a unified set of reusable feature profiles, to automatically construct rich and user-specific prompts for the generative AI model, and thereby to improve computational efficiency, reduce model input size and latency, and provide more consistent and individualized text and voice generation compared to conventional systems.

The term “terminal” refers to an electronic device operated by a user, the device being configured to transmit information to and receive information from a server over a communication network, and to provide input and output interfaces such as a display, a touch panel, or other user interface components.

The term “structured information” refers to information organized according to a predetermined format or schema, including but not limited to tabular data or serialized records, the information comprising fields such as timestamps, sender identifiers, and character information.

The term “character information” refers to textual content expressed as a sequence of characters, symbols, or codes, which is derived from user messages or other text-based communications.

The term “user identification information” refers to information that uniquely or quasi-uniquely identifies a user or an account, including identifiers such as user IDs, account names, telephone numbers, or email addresses.

The term “associated information” refers to metadata or auxiliary data linked to character information, including but not limited to timestamps, device identifiers, message IDs, or system-generated annotations that are not required for analysis of linguistic style.

The term “natural language processing” refers to a series of computational techniques for analyzing and processing human language text, including operations such as tokenization, morphological analysis, part-of-speech tagging, parsing, and statistical feature extraction.

The term “segmentation into morpheme units” refers to a processing operation that divides character information into minimal meaningful linguistic units, such as words or morphemes, which can be individually analyzed for grammatical or statistical properties.

The term “statistical values” refers to numerical measures computed from character information or tokens, including but not limited to term frequencies, co-occurrence counts, n-gram frequencies, or term importance scores.

The term “language feature information” refers to data representing linguistic characteristics of a user's text, the data including frequent expressions, style feature quantities, and other numerical or symbolic descriptors of language usage patterns.

The term “frequent expressions” refers to words, phrases, or n-grams that occur repeatedly in a user's character information and are statistically determined to represent characteristic usage.

The term “style feature quantities” refers to numerical or categorical indicators that describe aspects of a user's writing style, including average sentence length, punctuation patterns, degree of formality, use of specific expressions, or other stylistic attributes.

The term “storage information” refers to information stored in a memory or storage medium, including structured records, indexes, and other data structures used to hold profiles, feature data, and associated information.

The term “user language profile” refers to a data structure maintained in storage information that aggregates language feature information for a specific user, the data structure being indexed or keyed by a user identifier and reusable across multiple generation operations.

The term “generation request information” refers to information received from a terminal that requests generation of text, the information including at least a prompt sentence and optionally additional parameters such as generation length or tone settings.

The term “prompt sentence” refers to a text input that specifies a content or instruction to a generative AI model, the text input serving as a starting point or condition for generation of response character information.

The term “generative AI model” refers to a computational model implemented by a machine learning architecture, such as a neural network, which is configured to generate new data, including text, based on input data or prompts.

The term “generation instruction information” refers to information constructed by the server for input to the generative AI model, the information including at least a prompt sentence augmented with additional conditions such as style condition information or word-usage condition information.

The term “style condition information” refers to information specifying desired stylistic properties of generated text, such as tone, formality level, sentence length, or usage of certain linguistic patterns, which is derived from the user language profile.

The term “word-usage condition information” refers to information specifying preferred or characteristic words, phrases, or expressions to be used or emphasized in generated text, the information being derived from language feature information.

The term “response character information” refers to text generated by the generative AI model in response to generation instruction information, the text reflecting both the semantic content of the prompt sentence and stylistic characteristics encoded by the user language profile.

The term “voice information” refers to audio data representing speech captured from a call or other voice communication, including waveforms or encoded audio streams.

The term “voice quality feature quantities” refers to numerical descriptors of acoustic characteristics of a speaker's voice, such as pitch, timbre, formant structure, speaking rate, and other spectral or temporal properties.

The term “speaking-tone feature quantities” refers to numerical or categorical descriptors of prosodic patterns in speech, such as intonation contours, rhythm, stress patterns, volume variations, and other temporal modulations that characterize speaking manner.

The term “past image information” refers to image data or video frames captured previously and associated with a user, the data depicting at least a person's appearance.

The term “person appearance feature quantities” refers to descriptors extracted from image information that represent visual attributes of a person, including but not limited to facial structure, hair style, clothing patterns, color distributions, or other appearance-related features.

The term “virtual person information” refers to data representing a digital character or avatar generated based on person appearance feature quantities, the data enabling rendering or simulation of a person-like figure in visual or interactive form.

The term “synthetic voice information” refers to audio data generated by a speech synthesis process, the data being produced from text and voice feature quantities so as to imitate or approximate a user's voice quality and speaking tone.

The term “pseudo-communication experience” refers to an interaction presented to a user through generated text or synthetic voice that simulates communication with a specific person, by reproducing that person's linguistic style, voice characteristics, or appearance-based behavior.

In one embodiment, a server cooperates with at least one terminal operated by a user to provide personalized communication based on a user language profile, voice feature quantities, and virtual person information. The server comprises at least one processor, a memory device, a non-volatile storage device, and a network interface. The terminal comprises a processor, a memory, a display unit such as a liquid crystal display or organic light-emitting diode display, an input device such as a touch panel or keyboard, and optionally a microphone and a camera. The server and the terminal communicate through a communication network, such as a packet-switched network using a transport protocol.

The server executes a set of software modules on a general-purpose computing platform. In one example, the server executes an operating system, a web application framework, a database management system, a natural language processing library, a numerical computation library, and an inference engine for a generative AI model. The server, for example, executes a scripting language runtime, a statistics and data analysis library (such as a tabular-data processing library), a natural language processing library (such as a tokenizer and morphological analyzer), and a machine learning library for computing TF-IDF vectors and for hosting or invoking a transformer-based neural network.

The server stores, in the memory, program modules including a communication module, a data preprocessing module, a language feature extraction module, a user language profile management module, a voice feature extraction module, an image analysis and virtual person generation module, a prompt construction module for a generative AI model, and a response post-processing module. These modules are implemented as executable instructions that, when executed by the processor, cause the processor to perform the functions described below.

The terminal transmits structured information including past character information to the server. The terminal, for example, allows the user to select a file exported from a messaging service, the file being stored in a local file system in a tabular format such as a delimited text file. The terminal reads the selected file using an operating system file interface, and transmits the file content to the server by an application protocol over a secure channel. The terminal includes a user identifier or a session token in a header field of a request such that the server can link the uploaded file to a specific user.

The server receives the structured information and stores the raw file in a storage region associated with the user. The server then executes the data preprocessing module to normalize the structured information. The server loads the file into a tabular data structure stored in main memory, identifies columns containing character information, timestamps, and sender identifiers, and removes user identification information and associated metadata that are not necessary for linguistic analysis. The server, for example, removes account identifiers, device identifiers, and system notification messages by applying pattern matching using regular expressions and by filtering rows that do not satisfy predetermined criteria.

The server converts the remaining character information into a normalized representation. The server applies character encoding normalization and removes control characters and markup tags. The server may also unify whitespace and convert various typographical variants to canonical forms. As a result, the server generates a clean character corpus in which each record includes at least a normalized text segment and a timestamp.

The server executes the language feature extraction module on the normalized corpus to generate language feature information. The server uses a natural language processing library to segment each text segment into morpheme units or tokens. The server performs part-of-speech tagging and lemmatization so that different inflected forms of a word can be treated as the same basic form for statistical analysis. The server then computes statistical values such as term frequency, document frequency, and co-occurrence counts for unigrams and multi-word expressions. The server may use a numerical computation library to construct a sparse matrix representation of a term-document matrix.

The server computes TF-IDF (Term Frequency-Inverse Document Frequency) values from the term-document matrix. The server applies a weighting scheme in which a weight for a term is proportional to its frequency in a user's messages and inversely proportional to its frequency across all messages, so that characteristic terms of the user are highlighted. The server selects terms and phrases whose TF-IDF scores exceed a threshold and stores these as frequent expressions. The server further derives style feature quantities by computing average sentence length, distribution of punctuation marks, frequency of emotive symbols, ratio of different grammatical categories, and other stylistic statistics over the user's text.

The server aggregates the frequent expressions and the style feature quantities into a data structure referred to as a user language profile. The server stores the user language profile in the memory and a persistent storage, with an index keyed by a user identifier. The user language profile includes, for example, a list of frequent expressions, a vector of style feature quantities, and summary TF-IDF vectors. The server may also store the profile in a vector database or a specialized feature store to enable rapid retrieval during later generation requests.

The server executes the voice feature extraction module when voice information is available. The terminal, in one embodiment, records voice information from a call using a built-in microphone and transmits encoded audio data to the server. The server decodes the audio stream and applies signal processing algorithms to extract voice quality feature quantities and speaking-tone feature quantities. The server, for example, computes a mel-frequency cepstrum coefficient representation of the audio, estimates a fundamental frequency contour, measures speech rate, and detects energy variations across time. These measures are stored as numerical vectors that capture the timbre, pitch, rhythm, and intonation patterns characteristic of the user's voice. The server stores these voice feature quantities in association with the user language profile in the memory and persistent storage.

The server executes the image analysis and virtual person generation module when past image information is available. The terminal, as an example, captures images or video frames of the user using a camera and transmits the image data to the server. The server applies an image analysis algorithm, such as a convolutional neural network trained for face and feature detection, to extract person appearance feature quantities including facial geometry, skin tone distribution, hair style, and typical clothing patterns. The server transforms these quantities into a parametric representation suitable for avatar generation. The server then generates virtual person information, which may comprise a set of parameters for a three-dimensional model, a two-dimensional character representation, or a combination thereof. The server stores the virtual person information in association with the user language profile and voice feature quantities.

The server constructs generation instruction information for a generative AI model by combining a prompt sentence supplied by the user with style condition information and word-usage condition information derived from the user language profile. The user, operating the terminal, enters a prompt sentence into an input field. For example, the user may type:

“Talk about what I did this weekend in my usual chat style.”

“Write a casual message to my friend to cancel tonight's dinner, in my own tone.”

“Summarize my busy week in a way that sounds like me.”

“Draft a birthday message to my best friend using my typical expressions and style.”

“Write a reply to ‘Can we reschedule to tomorrow?’ that sounds like my normal messages.”

The terminal transmits the prompt sentence together with a user identifier to the server.

The server retrieves the corresponding user language profile from storage and passes it to the prompt construction module. The server, in one embodiment, constructs a structured instruction consisting of a system-level portion, a profile-based portion, and a user-level portion. The system-level portion defines the general role and constraints of the generative AI model, such as an instruction to follow the user-specific style. The profile-based portion explicitly lists representative frequent expressions and describes quantified style properties. The user-level portion contains the prompt sentence received from the terminal.

The generative AI model is, in one embodiment, a transformer-based neural network comprising multiple self-attention layers and feed-forward layers, trained on a large corpus of textual data. The server stores the parameters of the generative AI model in the memory or accesses an external model through an inference interface. During operation, the server performs inference by supplying tokenized input sequences representing the generation instruction information to the model. The model computes, in each layer, attention weights over input tokens, aggregates contextual representations, and updates hidden states through matrix multiplications and non-linear activation functions. The server sets decoding parameters such as temperature, top-k or top-p sampling thresholds, and maximum output length to control the diversity and length of generated text.

In some embodiments, the server fine-tunes the generative AI model on user-specific data to improve alignment with the user language profile. The server collects a subset of the normalized corpus and uses it as a fine-tuning dataset. The server defines a loss function, for example a cross-entropy loss between predicted token distributions and actual tokens, and performs gradient-based optimization of model weights using a stochastic gradient descent algorithm or a variant thereof. The server may apply data augmentation techniques, such as paraphrase generation or back-translation, to expand the fine-tuning dataset. By incorporating the user's own historical text into the training process, the server decreases prediction error for user-specific expressions and stylistic patterns. The server thereby achieves higher fidelity in reproducing the user's typical language and reduces the need to supply long histories in every generation request.

When the server executes the generative AI model with the constructed generation instruction information, the server obtains response character information that reflects both the semantic intent of the prompt sentence and the stylistic constraints imposed by the user language profile. The server applies the response post-processing module to enforce additional constraints, such as length limitations, elimination of incomplete sentences, or removal of inappropriate content according to predetermined rules. The server then transmits the response character information to the terminal.

The terminal displays the response character information on the display unit. The terminal may present the generated text in a dedicated user interface as a message bubble or text area. The user reads the generated text, and may manually edit the text or supply a new prompt sentence if the user desires a different style or content. The terminal can also forward the generated text to another communication application upon user operation.

In one embodiment, the server combines the response character information with the voice feature quantities to generate synthetic voice information. The server uses a neural vocoder or a parametric text-to-speech synthesizer configured to accept text input and voice feature vectors. The server feeds the response character information along with the user's voice quality feature quantities and speaking-tone feature quantities into the synthesizer, which produces an audio waveform imitating the user's voice characteristics. The server transmits the synthetic voice information to the terminal. The terminal outputs the synthetic voice information through a speaker, thereby providing a pseudo-communication experience in which the system speaks in a manner approximating the user's own voice and tone.

In another embodiment, the server also uses the virtual person information in a graphical interface. The terminal, executing a rendering module, receives parameters describing the virtual person and animates the avatar synchronized with the synthetic voice or displayed text. This combined use of text generation, voice synthesis, and avatar rendering produces a more immersive representation of the user's characteristic communication behavior.

From a technical perspective, the described architecture provides improvements to computer technology beyond a mere automation of human activity. The server precomputes and stores user language profiles, voice feature quantities, and appearance feature quantities in structured data formats. This allows the server to avoid repeatedly reprocessing large volumes of raw historical data for every generation request. The server thereby reduces computation time and resource usage in subsequent operations, which results in lower latency and lower energy consumption on the server hardware. The explicit separation between historical analysis and generation-time prompt construction enables the server to supply compact, information-dense conditions to the generative AI model rather than long, redundant histories, which reduces the length of model input sequences and improves inference efficiency.

Furthermore, the use of specific statistical features and learned parameters as an intermediate representation yields a more stable and reproducible style than simply concatenating raw text examples. The server employs non-conventional processing sequences that combine classical natural language statistics (such as TF-IDF and n-gram frequencies) with neural network outputs from a transformer architecture. The server enforces explicit style and word-usage constraints at the token-level decoding stage, for instance by modifying token probability distributions according to the user language profile. This combined rule-based and neural approach enables the system to control the model's generation behavior in ways that are not achievable by human manual editing alone.

The server's training and fine-tuning processes also provide technical effects. By using cross-entropy loss and gradient-based optimization, and by augmenting limited user data with automatically generated paraphrases, the server decreases generalization error for the user's style while preserving baseline language competence. This improves the accuracy of style reproduction and reduces the need for long contexts, which in turn decreases memory usage and computational complexity per request. The use of learned vector representations for user style also facilitates indexing and retrieval in a vector database, enabling efficient querying for similar profiles or style transfer across different users, if desired.

In alternate embodiments, the server may employ different machine learning architectures, such as recurrent neural networks or encoder-decoder models, for the generative AI model. The server may also use alternative feature extraction algorithms, such as topic modeling for discovering latent themes in user messages, or prosody modeling algorithms for more detailed speaking-tone analysis. The underlying data structures can also vary; for example, the server may store user language profiles as serialized objects, as relational database entries, as graph nodes in a knowledge graph, or as vectors in a high-dimensional vector space.

In some variations, the terminal performs a subset of the preprocessing, such as initial tokenization or noise removal, before transmitting character information to the server. This can reduce network bandwidth consumption and distribute computational load between the client and server. In other variations, the server may cache partially processed intermediate representations so that repeated prompts in similar contexts can be fulfilled with minimal recomputation. In yet other embodiments, the server may provide interfaces for multiple generative AI models and select an appropriate model according to profile complexity, target language, or latency constraints.

Because the server tightly integrates data preprocessing, multi-modal feature extraction, profile construction, and controlled generative AI inference into a single coherent pipeline, the system yields improved performance in terms of response time, resource utilization, and consistency of style reproduction. The combination of explicit algorithmic steps, specific data structures, and trained neural network processing produces a technical effect of more efficient and accurate personalization compared to conventional systems that rely solely on generic prompts or manual template creation.

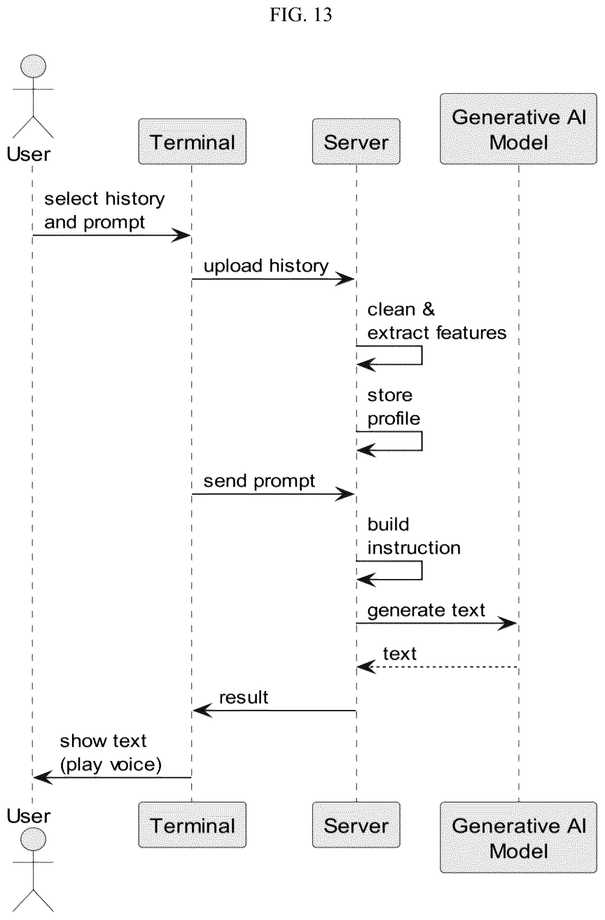

The following describes the processing flow using FIG. 13.

### Step 1

The user operates the terminal to provide past communication data.

The user selects a file containing past messages, for example a chat history file exported from a messaging service in a tabular text format, using a file selection interface on the terminal.

Input: a file stored in local storage that includes at least timestamps, sender identifiers, and message text.

The terminal reads the file through an operating system file I/O API and packages the file content together with a user identifier into a request message. The terminal then transmits the request to the server over a network using a secure transport protocol.

Output: a network request containing structured information including past character information and user identification information, sent from the terminal to the server.

### Step 2

The server receives and stores the structured information.

The server accepts the network request via a communication module, parses the request headers to obtain the user identifier, and parses the payload to retrieve the structured information.

Input: a network request from the terminal including a user identifier and a structured file payload.

The server writes the raw file to a temporary storage region, and stores a record in a database associating the file path with the user identifier and a timestamp. The server then loads the structured information into a tabular in-memory data structure.

Output: a raw data record in persistent storage and an in-memory table of structured information indexed by the user identifier.

### Step 3

The server preprocesses the structured information to extract normalized character information.

The server examines the in-memory table to identify and retain columns corresponding to timestamps, sender identifiers, and message text, and discards columns such as device identifiers or export metadata.

Input: an in-memory table of structured information containing multiple columns and rows.

The server filters out rows corresponding to system notifications or non-message entries by applying pattern matching rules to the message text column. The server then normalizes character encoding, removes control characters and markup tags, and unifies whitespace and typographical variants. These operations are performed through string processing functions and regular expressions.

Output: a cleaned corpus table in memory, in which each row contains at least a normalized text segment and a timestamp, with unnecessary user identification information and associated metadata removed.

### Step 4

The server performs natural language analysis on the normalized corpus to generate language feature information.

The server uses a natural language processing library to segment each text segment into morpheme units or tokens, and to assign part-of-speech tags and lemmas.

Input: the cleaned corpus table containing normalized text segments.

The server iterates over each row, passes the text segment to a tokenizer and morphological analyzer, and obtains a token sequence with linguistic attributes. The server then computes statistical values such as term frequency, document frequency, and n-gram frequencies by aggregating token occurrences across all messages. The server constructs a term-document matrix and calculates TF-IDF scores for each term. Based on these scores and other statistics, the server identifies frequent expressions and computes style feature quantities, such as average sentence length, punctuation usage ratios, and distribution of grammatical categories.

Output: language feature information for the user, including at least a list of frequent expressions and a vector of style feature quantities.

### Step 5

The server constructs and stores a user language profile.

The server aggregates the language feature information into a structured profile data object associated with the user identifier.

Input: a user identifier, a list of frequent expressions, and a set of style feature quantities derived from the normalized corpus.

The server organizes these elements into a predefined schema that may include fields for frequent single words, frequent multi-word expressions, summary TF-IDF vectors, and numerical style indicators. The server then writes this profile object into a persistent storage system, such as a relational database or a feature store, indexed by the user identifier.

Output: a stored user language profile that can be retrieved efficiently for subsequent generation requests.

### Step 6

The server processes voice information to extract voice feature quantities.

The terminal, in response to user permission, records voice information from calls using a microphone and transmits encoded audio streams to the server.

Input: encoded audio data associated with a user identifier, received by the server.

The server decodes the audio data into digital waveforms and applies signal processing algorithms to compute acoustic descriptors. The server calculates, for example, spectral coefficients, pitch contours, energy envelopes, and temporal statistics that represent voice quality and speaking tone. These values are aggregated into vectors representing voice quality feature quantities and speaking-tone feature quantities. The server then associates these vectors with the user identifier and stores them in persistent storage together with the user language profile.

Output: stored voice feature quantities (voice quality and speaking tone) linked to the user language profile.

### Step 7

The server processes image information to generate virtual person information.

The terminal captures image information of the user using a camera and transmits image frames or image files to the server.

Input: image data representing a person's appearance, received by the server along with a user identifier.

The server applies an image analysis algorithm, such as a feature extractor based on a convolutional neural network, to detect a face region and estimate facial landmarks, color distributions, and other appearance attributes. The server encodes these attributes into person appearance feature quantities, such as vectors for facial geometry, hair style, and clothing patterns. The server converts these feature quantities into parameters for a virtual avatar or digital character and stores the resulting virtual person information in association with the user language profile and the voice feature quantities.

Output: stored virtual person information corresponding to the user's appearance, linked to the user language profile and voice feature quantities.

### Step 8

The user supplies a prompt sentence through the terminal.

The user opens a user interface on the terminal and inputs a natural language instruction or request in a text field.

Input: a text string entered by the user, for example: “Talk about what I did this weekend in my usual chat style.”

The terminal reads the text from the input field, associates it with the user identifier, and constructs a generation request message. The terminal then sends the generation request to the server over the network.

Output: a network request containing the prompt sentence and the user identifier, transmitted to the server.

### Step 9

The server constructs generation instruction information for a generative AI model.

The server receives the generation request, parses the request to extract the user identifier and the prompt sentence, and retrieves the corresponding user language profile from storage.

Input: the prompt sentence and the stored user language profile for the user.

The server examines the frequent expressions and style feature quantities in the user language profile, and generates style condition information and word-usage condition information that specify, for example, preferred tone, sentence length, and characteristic expressions. The server then constructs a composite textual instruction that includes the prompt sentence and additional explanatory text describing how the generative AI model should emulate the user's style. The server represents this composite instruction in a format suitable for the generative AI model, such as a concatenated string or a structured message sequence.

Output: generation instruction information that combines the user's prompt sentence with profile-derived style and word-usage conditions.

### Step 10

The server invokes the generative AI model and generates response character information.

The server tokenizes the generation instruction information into a sequence of tokens and supplies this sequence to a transformer-based generative AI model hosted locally or accessed through an inference interface.

Input: tokenized generation instruction information including the prompt sentence and style constraints.

The generative AI model processes the token sequence layer by layer, computing attention weights and updating internal hidden states to predict probability distributions over possible next tokens. The server iteratively samples or selects tokens according to these distributions, subject to decoding constraints such as maximum length and sampling thresholds, to generate a sequence of output tokens. The server converts the output tokens back into text to obtain the response character information.

Output: response character information in text form that reflects both the content specified by the prompt sentence and the stylistic constraints derived from the user language profile.

### Step 11

The server optionally generates synthetic voice information from the response character information.

The server retrieves the stored voice feature quantities associated with the user and feeds both the response character information and these feature quantities into a text-to-speech synthesis engine.

Input: response character information and voice quality feature quantities and speaking-tone feature quantities for the user.

The synthesis engine converts the text into an intermediate phonetic or acoustic representation and then generates a waveform while modulating pitch, timbre, and prosody according to the feature quantities. The server obtains an audio stream that imitates the user's voice and speaking tone.

Output: synthetic voice information corresponding to the response character information, suitable for playback on the terminal.

### Step 12

The terminal outputs the generated result to the user.

The terminal receives from the server either the response character information alone or both the response character information and the synthetic voice information.

Input: a response message from the server containing generated text and optionally generated audio data.

The terminal displays the response character information in a text display region, rendering the characters on the display unit. If synthetic voice information is present, the terminal decodes the audio data and drives a speaker to output the sound. The user reads or listens to the generated content and may decide to accept it, edit it, or issue a new prompt sentence, thereby repeating the generation cycle as desired.

Output: a visual and optionally auditory presentation of the generated response to the user on the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that attempt to personalize content or virtual representations of users typically rely on a single type of input signal, such as click-through logs, static profile attributes, or coarse sentiment scores from isolated text messages. Such systems generally do not integrate multimodal signals, such as voice characteristics, fine-grained textual style, facial expressions, and real-time movements, into a coherent computational model of a user. As a result, existing systems are limited in their ability to generate recommendations, dialogues, or avatar behaviors that faithfully reflect the user's personality, preferences, and emotional state in real time.

In particular, in many current architectures, raw multimedia inputs (audio, text, images, video) are either stored in a high-dimensional, unstructured form that is difficult to reuse, or are reduced to simplistic labels that discard rich stylistic and temporal information. This leads to technical inefficiencies: downstream generative models cannot be driven by compact, semantically meaningful feature vectors; prompt construction is ad hoc and does not systematically encode user-specific style or emotion; and user profiles are static and fragmented across separate subsystems. Consequently, processing pipelines suffer from increased latency, poor controllability of generative outputs, and low consistency between a user's real-world behavior and the system's generated content or virtual person behavior.

Furthermore, conventional systems generally lack a standardized mechanism for transforming multimodal user data into structured prompt sentences for a generative information processing model. Without such a mechanism, it is difficult to (i) combine historical style features with current context and emotion, (ii) constrain the model to output in desired formats, and (iii) update virtual persons or recommendation results in real time as new sensor data arrives. This deficiency limits the practical integration of generative models into interactive applications such as virtual spaces, communication assistance tools, and adaptive content platforms.

Accordingly, there is a need for an improved computer-implemented system that: (1) acquires multimodal user data, including call audio, message text, and image frames, (2) extracts non-identifying acoustic feature quantities, textual style feature quantities, and expression parameter sequences suitable for machine processing, (3) constructs unified user profile data encoding preferences and emotional states, and (4) automatically generates structured prompt sentences for a generative information processing model to produce content candidates, dialogue sentences, and virtual person behavior instructions. There is also a need to technically improve how virtual persons are generated and controlled so that their expressions and movements can be updated in real time in response to the computed user profile and the generative model's output, thereby improving the functionality, accuracy, and responsiveness of computer systems that support personalized interactive experiences.

The specific processing by the specific processing unit 290 of the data processing device 12 in Application Example 2 is realized by the following means.

The present invention provides a server comprising a processor configured to acquire voice signals from calls and transform the voice signals into acoustic feature quantities and speech prosody in a format in which a speaker cannot be identified, to acquire text information from message data and generate style feature quantities indicating user-specific expression characteristics by natural language processing, to detect face regions from image data and generate feature information for virtual person models, to analyze image frames from terminal devices and generate expression parameter sequences for real-time control of virtual persons, to estimate user preference information and emotional states based on the acoustic feature quantities, the style feature quantities, and the expression parameter sequences and generate user profile data including the preference information and the emotional states, to construct prompt sentences for input to a generative information processing model according to the user profile data and current usage situations and acquire response data from the generative information processing model, and to generate content candidates, dialogue sentences, or behavior instructions for virtual persons based on the response data and output the generated results to terminal devices. This enables a technical improvement to computer functionality by providing a unified, machine-optimized representation of multimodal user data that drives structured prompt sentence generation for a generative information processing model, thereby allowing the system to compute personalized recommendations and real-time virtual person behaviors with reduced processing redundancy, improved controllability of generative outputs, and enhanced alignment between user states and system responses.

The term “voice signals” refers to analog or digital audio data representing human speech captured from a communication session such as a telephone call or voice over packet communication.

The term “call” refers to a communication session in which audio signals conveying speech are exchanged between two or more endpoints over a wired or wireless communication network.

The term “acoustic feature quantities” refers to numerical values computed from voice signals, including but not limited to spectral coefficients, pitch statistics, energy measures, and speaking rate, which characterize the acoustic properties of the speech without directly storing the raw waveform.

The term “speech prosody” refers to temporal and intonational characteristics of speech, including pitch contour, rhythm, stress, and duration patterns, that reflect how an utterance is spoken rather than what words are used.

The term “format in which a speaker cannot be identified” refers to a data representation in which personally identifying information is removed or abstracted such that an individual speaker cannot reasonably be re-identified from the stored data.

The term “text information” refers to character sequences representing linguistic content, including words, symbols, and punctuation, obtained from message data, transcripts, or other textual sources.

The term “message data” refers to electronic communication records, including chat messages, emails, and similar textual exchanges, that contain user-generated text suitable for analysis.

The term “vocabulary usage tendencies” refers to statistical patterns in how words, phrases, and symbols are selected and combined by a user over multiple messages.

The term “sentence structures” refers to syntactic patterns of how words and phrases are arranged into clauses and sentences, including ordering, complexity, and dependency relations.

The term “writing style patterns” refers to recurring characteristics of textual expression, such as sentence length distribution, formality level, use of exclamations or questions, and characteristic phrases.

The term “emotional tendencies” refers to patterns in affective content inferred from text, such as a user's frequent expression of positive, negative, or specific nuanced emotions over time.

The term “style feature quantities” refers to numerical representations of a user's characteristic language use, including vocabulary, syntax, and style metrics, derived from text information for computational processing.

The term “user-specific expression characteristics” refers to distinctive linguistic patterns, stylistic preferences, and habitual expressions that differentiate one user's text from that of other users.

The term “face region” refers to a portion of image data containing a human face, identified by a detection algorithm as an area of interest for further facial analysis.

The term “image data” refers to digital data representing visual information such as photographs or video frames suitable for processing by an image analysis algorithm.

The term “facial feature points” refers to specific, algorithmically detected locations on a face, such as eye corners, nose tip, and mouth corners, used to describe facial geometry and expressions.

The term “shape parameters” refers to numerical values describing geometric properties of a face or model, including dimensions, contours, and relative positions of facial components.

The term “feature information for a virtual person model” refers to structured data derived from facial feature points and shape parameters, used to configure or deform a rendered representation of a person.

The term “virtual person” refers to a computer-generated representation of a human, expressed as a three-dimensional shape model or a two-dimensional character model, that can be displayed and animated.

The term “three-dimensional shape model” refers to a digital representation of an object or character defined in three-dimensional space by vertices, edges, surfaces, and associated attributes.

The term “two-dimensional character model” refers to a digital representation of a character defined in a two-dimensional coordinate space, including sprites or layered images suitable for animation.

The term “image frames” refers to individual still images extracted from a time-varying visual signal such as a video stream captured by an imaging element.

The term “imaging element” refers to a hardware component, such as an image sensor or camera module, that converts light into digital image data.

The term “terminal device” refers to a user-operated electronic apparatus, such as a mobile device, computer, or display device, that captures user data and presents output from a server.

The term “facial expression changes” refers to temporal variations in facial muscle configurations, observable in image data, that convey different affective or communicative states.

The term “head movements” refers to changes in orientation, position, or motion of a user's head detected from image frames.

The term “expression parameter sequence” refers to a time-ordered series of numerical values representing facial expressions and head movements for use in controlling an animated model.

The term “real-time control” refers to updating an output, such as a virtual person's expression or movement, with latency sufficiently low that a user perceives the response as immediate or near-immediate.

The term “user preference information” refers to data indicating a user's likes, dislikes, interests, or favored content categories, inferred from multimodal inputs.

The term “emotional states” refers to inferred affective conditions of a user, such as joy, anger, sadness, or neutrality, derived from analyzed multimodal data.

The term “user profile data” refers to structured information representing a user's preferences, emotional tendencies, and characteristic behaviors, stored for use in subsequent processing.

The term “prompt sentence” refers to a text instruction or set of instructions constructed for input to a generative information processing model to guide its output behavior.

The term “generative information processing model” refers to a computational model, such as a machine learning model, that generates new data or content, including text or control parameters, in response to input prompts.

The term “current usage situation” refers to contextual information describing how and under what conditions a user is interacting with the system at a given time, such as session type, application state, or environment.

The term “response data” refers to information output by a generative information processing model in response to a prompt sentence, including textual or structured data.

The term “content candidates” refers to one or more items of digital content, such as media items or information items, proposed for presentation to a user.

The term “dialogue sentences” refers to textual utterances generated for use in conversational interactions between the system and a user or between virtual entities.

The term “behavior instructions” refers to control parameters or commands that specify how a virtual person should move, gesture, or change expression.

The term “external information providing apparatus” refers to a remote or separate computing system, including servers or services, that supplies content or metadata via a communication network.

The term “video content” refers to digital media items containing moving images, optionally accompanied by audio, that can be rendered to a display.

The term “audio content” refers to digital media items containing sound, such as speech or music, that can be rendered to an audio output device.

The term “information acquisition function” refers to a capability of an apparatus or service to retrieve data or content, for example by executing search queries over a network.

The term “emotion analysis” refers to computational processing that estimates emotional states from input data such as acoustic features, text features, and expression parameters.

The term “emotion index” refers to a numerical or categorical representation of an inferred emotional state, including type and optionally intensity.

Server, terminal, and user cooperate to implement various embodiments of the invention so that a generative AI model can be driven by structured prompt sentences constructed from multimodal user data. Each embodiment is described below with specific hardware, software, data structures, and processing flows that a skilled person can implement.

Server may be implemented as one or more computing devices including a central processing unit, a memory subsystem, a nonvolatile storage device, and a network interface. Terminal may be implemented as a mobile device, a wearable device, or a stationary computer including a processor, a camera, a microphone, a display, and a communication interface. User operates terminal and provides speech, text, and image inputs.

Server executes an operating system such as a general-purpose server operating system and provides application processes for audio analysis, natural language processing, image processing, emotion analysis, profile construction, prompt sentence generation, and interaction with a generative AI model. Server uses general-purpose software libraries as described below, such as an audio analysis library (for example, a Librosa-type library), a natural language processing library (for example, an NLTK-type or spaCy-type library), an image processing library (for example, an OpenCV-type library), a machine learning framework (for example, a TensorFlow-type framework), and a rendering or model generation tool (for example, a Blender-type or Unity-type tool). Terminal executes an application that controls the camera and microphone, sends captured data to server, renders a virtual person using a game engine (for example, a Unity-type or Unreal-type engine), and presents recommendations and dialogue text.

Server stores structured data in a database system such as a relational database management system. Server defines tables for acoustic feature quantities, style feature quantities, image-based face feature records, expression parameter sequences, user profile data, prompt sentences, response data, and log information. Server defines schema so that each record is associated with a user identifier, a timestamp, and a context identifier (for example, “virtual store,” “chat room,” “media recommendation”).

Server uses a specific feature representation to improve computational efficiency. Server represents acoustic feature quantities as multi-dimensional arrays of floating-point numbers, such as mel-frequency cepstral coefficients, pitch statistics, and energy values. Server represents style feature quantities as normalized vectors including term frequency-inverse document frequency values, sentence length statistics, syntactic pattern counts, and sentiment scores. Server represents expression parameter sequences as time-ordered vectors of facial action parameters and head pose parameters. These representations allow server to perform similarity searches, clustering, and regression efficiently using matrix operations on a numerical computing library.

Server implements a neural network-based generative information processing model in some embodiments. Server may host a transformer-type language model having multiple self-attention layers, feed-forward layers, and layer normalization. Server trains such a model on a corpus of conversational text, including augmented data that mimics user-specific style distributions. Server defines a loss function that combines next-token prediction loss with an auxiliary style consistency loss, where the model is penalized if generated text deviates from the style feature quantities of the input profile. Server updates model weights using a gradient descent-based optimization algorithm, such as Adam, with mini-batch training, backpropagation through time, and learning-rate scheduling. Server may pretrain the generative AI model offline and then fine-tune it on anonymized user interaction logs.

Server constructs prompt sentences as structured inputs to the generative AI model. Server not only concatenates plain text, but also encodes user profile data into a consistent template that the model has been trained to interpret. For example, server may generate a prompt sentence such as:

“User profile: prefers action movies and games; writes in short, casual sentences with frequent exclamation marks; typical emotions: joy and excitement. Current context: user is in a joyful mood and is requesting recommendations. Task: recommend five newly released action movies suitable for an energetic and optimistic user. Output format: list with title, year, and one-sentence description.”

Server uses this type of structured prompt to ensure that the generative AI model produces outputs that are aligned with stored profile data and current emotional context. This configuration improves technical performance because server can reuse the same internal template for different users and contexts and can automatically verify that the returned output matches the requested format.

Server, in other embodiments, generates prompt sentences for avatar dialogue. Server may generate a prompt sentence such as:

“You are simulating the user's speaking style for a virtual avatar. The user uses informal, friendly English, short sentences, and many exclamation marks, and often talks about movies and anime. The user's current emotion is ‘joy’. Reply to the user message: ‘I finally finished that game today!’ in the user's style in under 30 words.”

Server in this case supplies the generative AI model with style and emotion metadata so that the model's output can be mapped directly to speech synthesis prosody and avatar facial expressions.

Server improves computer technology by using these structured prompt sentences as an interface between compact feature representations and a generative AI model. Conventional systems often store raw text or raw speech and send loosely defined prompts, resulting in variable latency and inconsistent outputs. Server instead uses fixed templates with explicit fields for style, emotion, and task specification. This allows server to implement automatic post-processing: server can parse returned text for required tokens, measure alignment with the requested constraints, and quickly reject or adjust outputs that deviate from specifications. This reduces error rates and processing time in subsequent rendering and recommendation modules.

Server also implements a specific dataflow for multimodal profile construction. Server defines a pipeline where acoustic feature extraction, text style analysis, image-based facial feature extraction, and real-time expression analysis produce separate feature vectors with compatible dimensionality and scaling. Server then concatenates or fuses these vectors using a learned projection layer, implemented as a small neural network that maps the concatenated vector into a compact profile embedding. Server trains this projection layer using supervision derived from historical user behavior (for example, content consumption logs, feedback signals). This design improves technical efficiency by avoiding repeated feature computation for each generative AI call and by enabling vector-space operations, such as nearest-neighbor retrieval, to pre-filter candidate outputs before invoking the more expensive generative model.

Server, in another embodiment, uses a convolutional neural network or a transformer-based vision model for face region detection and facial feature point extraction. Server uses a loss function that combines landmark regression error with head-pose estimation error, and uses data augmentation methods such as random cropping, rotation, and lighting variation to improve robustness. This results in more accurate detection of facial expressions, which in turn yields more accurate expression parameter sequences. Because terminal can send only low-dimensional expression parameters instead of complete image frames in some modes, overall network communication load is reduced, which is a concrete technical improvement.

Terminal uses a camera module and a microphone module to capture user signals. Terminal may implement on-device pre-processing to reduce latency and bandwidth. For example, terminal can execute a lightweight face detection model and send only cropped facial regions or derived action parameters to server. By moving some computation to terminal, server load and network bandwidth consumption are reduced. Terminal uses a game engine to animate the virtual person, reading expression parameters from server or from local detection. Terminal maintains a mapping between action parameters and avatar rig controls, so that each incoming parameter update results in a direct change in bone rotations or blend shape weights. This arrangement allows terminal to update the virtual person at display refresh rates, such as 60 frames per second, thus creating the perception of real-time control.

User interacts with terminal in different usage scenarios. In one embodiment, user participates in a virtual space where a virtual person represents user's appearance and expression. User speaks into a microphone and sends text messages; terminal captures these signals and sends them to server. Server analyzes these signals, updates user profile data, generates prompt sentences, calls the generative AI model, and sends back dialogue sentences and control parameters. Terminal synthesizes speech from the generated text using a text-to-speech engine that accepts prosody parameters. Terminal synchronizes the synthesized speech with virtual person mouth movements and expression parameters so that the virtual person speaks and reacts in a way consistent with the user profile and current emotion.

User, in another embodiment, receives content recommendations on terminal. When user writes a message such as “I'm so happy today!” terminal transmits the text and current interaction context to server. Server updates an emotion index for user as “joy,” incorporates this into user profile data, generates a prompt sentence for recommendation, invokes the generative AI model, and retrieves recommended content candidates. Terminal displays the recommended items and may show a virtual person presenting them, with an expression reflecting the joyful state. This introduces a concrete technical effect: server adapts its content selection strategy in real time without recomputing full models, because server only updates the emotion index and modifies the prompt sentence.

Server applies non-conventional processing rules that differ from typical human work procedures. Human operators normally cannot integrate high-dimensional acoustic features, text style statistics, and facial expression parameters into a unified numerical representation and cannot construct prompts deterministically from such vectors. Server defines specific mapping functions from numerical vectors to text descriptors (for example, mapping high variance in pitch and high frequency of exclamation marks to “energetic speaking style”) and uses these descriptors systematically in prompt templates. This rule-based mapping improves repeatability and reduces subjective variance, leading to more consistent and technically predictable behavior of the generative AI model.

Server defines an internal module architecture that separates capture, feature extraction, profile fusion, prompt generation, model interaction, and output adaptation. Each module communicates via defined intermediate data structures, such as feature vectors and profile embeddings with specified dimensions. This modularization enables optimization at each stage. For example, server can cache profile embeddings and reuse them for multiple tasks; server can batch generative AI calls across users with similar profiles; and server can pre-compute default prompts for certain contexts. These design decisions reduce mean response time and increase throughput compared to naive end-to-end systems.

Server in some embodiments uses a recurrent update scheme for user profile data. Server maintains not only the latest profile embedding, but also a short history of embeddings with timestamps. Server applies an exponential smoothing algorithm or a recurrent neural network layer to derive a smoothed profile that reflects long-term tendencies and short-term deviations. This provides a technical effect by improving stability of model behavior: transient noise in input signals does not immediately cause large swings in recommendations or virtual person behavior, thereby reducing error and improving user experience.

Terminal in some embodiments can operate in a low-bandwidth mode. Terminal compresses audio signals using a codec and extracts on-device spectrogram features, sending only the compact features rather than raw audio. Terminal also compresses expression parameter sequences by delta-coding and quantization before transmission. Server reconstructs continuous parameter curves by interpolation. This design reduces network traffic and improves scalability when many terminals are connected simultaneously.

Server may use alternative types of generative information processing models. In one variant, server uses a sequence-to-sequence encoder-decoder model that encodes the prompt sentence and decodes a structured JSON-like text, which server then parses to fill recommendation lists or avatar commands. In another variant, server uses a diffusion-type generative model to generate avatar texture variations aligned with a textual description derived from user profile data. In all cases, server treats the generative AI model as a component that consumes structured prompt sentences based on multimodal features and returns data that is systematically post-processed.

Server thereby improves computer technology in several ways. Processing speed is improved because feature extraction and profile fusion allow server to pre-compute user-dependent information and reduce repeated computation for each interaction. Accuracy is improved because multimodal fusion and emotion-aware prompt generation give the generative AI model more precise context, reducing inappropriate or irrelevant outputs. Data management is improved through explicit schemas for feature quantities and profile data, enabling efficient indexing, caching, and analytics. Communication load is reduced through compact feature and expression parameter representations, which substitute for raw multimedia transmission.

Server, terminal, and user can be combined in various alternative embodiments. In some embodiments, server performs most processing centrally, and terminal acts primarily as a capture and display device. In other embodiments, terminal performs more computation, such as on-device face analysis and partial prompt construction, while server focuses on generative AI execution and long-term profile storage. In yet another embodiment, server can be partitioned into a feature server, a profile server, and a generation server, each optimized and possibly deployed in different data centers.

Server can also be configured to adjust parameters of the generative AI model at runtime according to user profile data. For example, server can set a lower sampling temperature when the user prefers stable, predictable text and a higher sampling temperature when the user profile indicates a liking for novelty. Server can adjust maximum output length, banned token lists, or style tags based on style feature quantities. This parameter control is not simply a human decision but is computed from numerical features, and it directly changes the internal sampling behavior of the model, leading to more technically controlled and efficient generation.

User thus experiences a system where voice, text, and expression inputs are captured and processed in ways that allow real-time, personalized, and technically efficient outputs. Server and terminal execute specific algorithms, data structures, and neural architectures that are optimized for machine execution, not mere human emulation. As a result, the system as a whole provides a concrete improvement to computer-implemented personalization and virtual interaction beyond simple automation of human tasks.

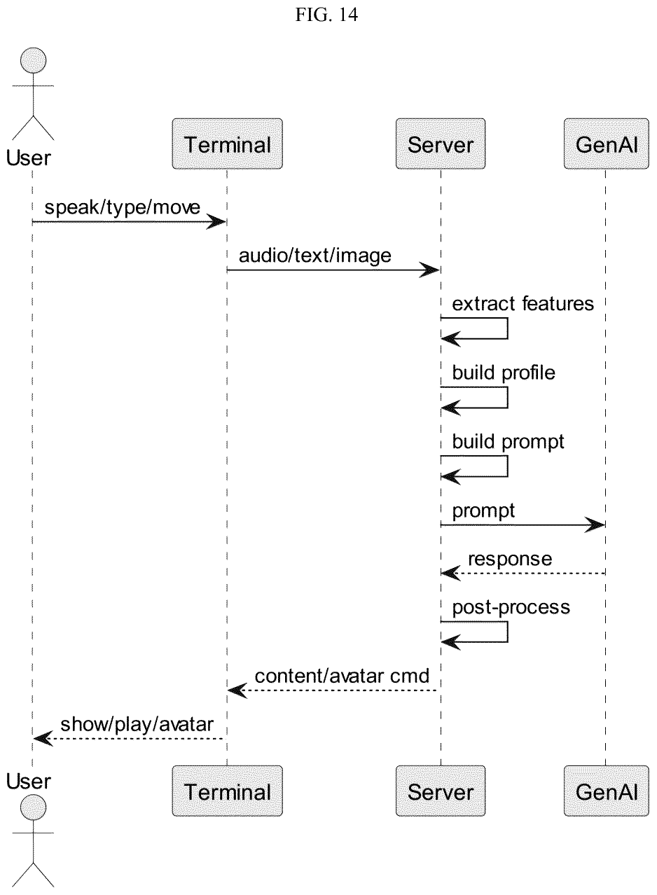

The following describes the processing flow using FIG. 14.

### Step 1

Terminal captures audio, text, and image inputs from the user and sends them to the server.

Terminal receives as input the user's voice through a microphone, the user's typed or selected text through a user interface, and the user's face images or video frames through a camera. Terminal converts the analog voice to digital audio frames, encodes the text as character strings, and compresses the image frames. Terminal performs basic preprocessing such as noise reduction on the audio and resolution adjustment on the images, and then outputs audio packets, text messages, and image data over a network connection to the server.

### Step 2

Server extracts acoustic feature quantities and speech prosody from the received audio packets.

Server receives as input the digital audio packets corresponding to user calls. Server segments the audio into fixed-length windows and applies an audio analysis algorithm to each window to compute mel-frequency cepstral coefficients, pitch contours, energy levels, and speaking rate. Server aggregates these values into acoustic feature vectors and normalizes them so that variations in recording hardware are reduced. Server outputs non-identifying acoustic feature quantities and prosody parameters and stores them in a feature database.

### Step 3

Server analyzes text messages and generates style feature quantities.

Server receives as input text messages sent from terminal or derived from speech recognition. Server runs a natural language processing pipeline that tokenizes the text, assigns part-of-speech tags, and parses sentence structures. Server computes statistics such as word frequency distributions, average sentence length, and occurrence counts of specific syntactic patterns. Server also applies a sentiment analysis function to obtain emotional polarity scores. Based on these computed values, server outputs a style feature vector that numerically represents user-specific expression characteristics and saves the vector in a profile storage.

### Step 4

Server detects face regions and extracts facial feature points and shape parameters from user images.

Server receives as input still images or selected video frames containing the user's face. Server applies a face detection algorithm to locate the face region and then runs a facial landmark detector to identify key points such as eye corners, nose tip, and mouth corners. Server computes geometric relationships between these points to derive face shape parameters such as jaw width, nose length, and eye separation. Server outputs a face feature record that includes the facial feature points and shape parameters and stores it as feature information for virtual person generation.

### Step 5

Server generates a virtual person model based on face feature records.

Server receives as input the stored face feature record for a particular user. Server loads a base three-dimensional head mesh or two-dimensional character template and applies a deformation algorithm that maps the face shape parameters to vertex displacements or control points of the template. Server adjusts the mesh or character shape so that its proportions approximate the user's facial geometry, and optionally fits textures based on image color information. Server outputs a virtual person model file and registers its location and configuration data in a model repository.

### Step 6

Terminal tracks real-time facial expressions and head movements of the user.

Terminal receives as input continuous video frames from the built-in camera during an interactive session. Terminal runs an on-device face tracking algorithm that detects the user's face in each frame and locates facial landmarks across successive frames. Terminal computes differences in landmark positions to detect facial expression changes and head pose variations over time. Terminal converts these differences into a compact sequence of expression parameters, such as blend-shape weights or head rotation angles, and outputs the expression parameter sequence either directly to the rendering engine or to the server.

### Step 7

Server estimates user preference information and emotional states from multimodal features.

Server receives as input acoustic feature quantities from audio, style feature vectors from text, and expression parameter sequences from images. Server aligns these data streams in time and applies a feature fusion algorithm, such as a weighted combination or a neural projection layer, to obtain a unified representation. Server then applies classification and regression models to this representation to infer preference information, such as favored content categories, and emotional states, such as joy, sadness, or neutrality. Server outputs user preference data and emotion labels with associated confidence scores and records them as user profile data.

### Step 8

Server constructs a user profile embedding from accumulated feature data.

Server receives as input historical acoustic features, style features, face features, expression parameters, and inferred preferences and emotions associated with a user. Server normalizes each feature type, concatenates them into a single high-dimensional vector, and applies a dimensionality reduction function or a small neural network layer to generate a compact profile embedding. Server may also smooth this embedding over time using an averaging or recurrent update method to account for long-term tendencies and recent changes. Server outputs a current profile embedding and stores it as a reference for subsequent processing.

### Step 9

Server generates a prompt sentence for a generative AI model based on the user profile and context.

Server receives as input the current profile embedding and context data that describe the current application state, such as “content recommendation” or “avatar dialogue.” Server decodes the profile embedding into human-readable descriptors, for example “prefers action movies,” “uses informal language,” and “current emotion: joy.” Server inserts these descriptors into a predefined prompt template corresponding to the requested task. Server outputs a prompt sentence that includes the user profile description, current emotional context, and explicit instructions for the generative AI model, such as the required output format and length constraints.

### Step 10

Server sends the prompt sentence to a generative AI model and receives response data.

Server receives as input the constructed prompt sentence. Server issues a request to a generative AI model endpoint over a network interface, embedding the prompt sentence in the request body. Server waits for the model to process the prompt and return generated text or structured content. Server receives the response text, which may include recommendations, dialogue sentences, or control descriptions, and parses it to extract identified fields or segments according to the requested format. Server outputs validated response data ready for downstream use and logs the prompt and response pair for monitoring.

### Step 11

Server post-processes the response data into content candidates or behavior instructions.

Server receives as input the validated response data from the generative AI model. Server interprets the response depending on the task: for content recommendation, server extracts item titles, brief descriptions, and category labels; for avatar dialogue, server extracts utterance text and inferred tone; for behavior instructions, server extracts symbolic commands such as “smile” or “nod.” Server may augment content candidates by querying external content sources using the extracted keywords and then merging external metadata with the response. Server outputs a finalized structure containing content candidates, dialogue sentences, and behavior instruction parameters.

### Step 12

Terminal renders recommended content and controls the virtual person based on server output.

Terminal receives as input the structure containing content candidates, dialogue sentences, and behavior instruction parameters. Terminal updates its user interface to display recommended items, including titles, icons, and selection controls. Terminal feeds dialogue sentences to a text-to-speech engine, optionally using tone parameters to adjust pitch, speed, and volume, and synchronizes the synthesized audio with the virtual person's mouth movements. Terminal applies behavior instruction parameters and expression parameters to the virtual person model in the rendering engine so that the virtual person exhibits the specified facial expressions and gestures. Terminal outputs an updated audiovisual presentation that reflects the user profile and the generative AI model's response.

### Step 13

User interacts with the rendered content and virtual person, generating new input for the system.

User receives as input the audiovisual presentation on terminal, including recommended content lists and virtual person behavior. User responds by selecting items, sending new messages, or changing facial expressions while looking at the display. User actions generate new audio, text, and image inputs that are captured again by terminal. User thereby closes the interaction loop, and the newly captured data are output from terminal to server, which continues to refine the user profile and subsequent prompt sentences.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

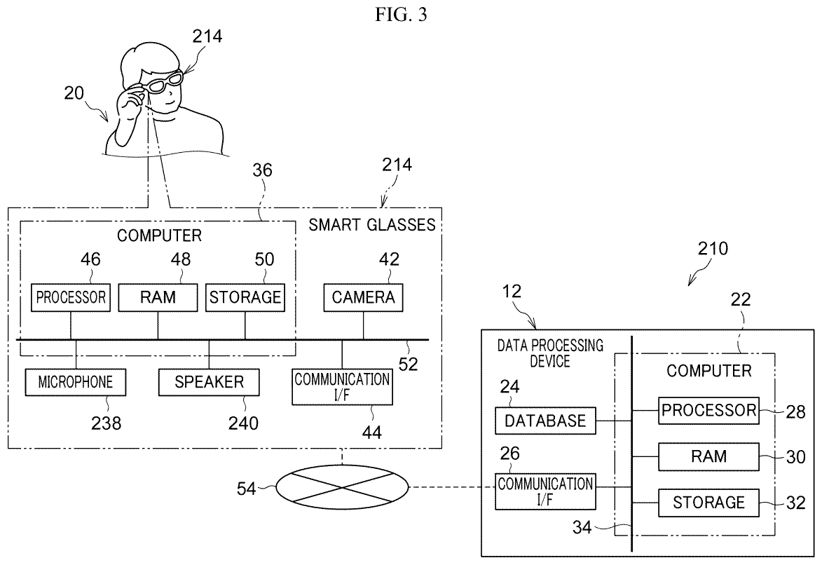

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

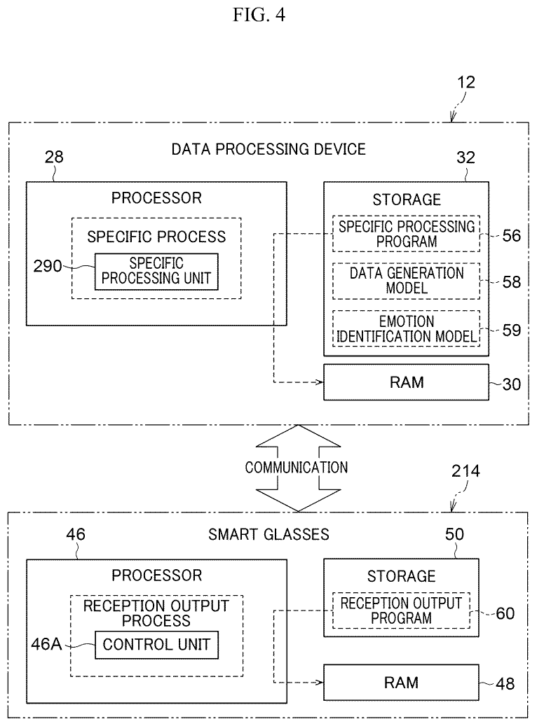

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

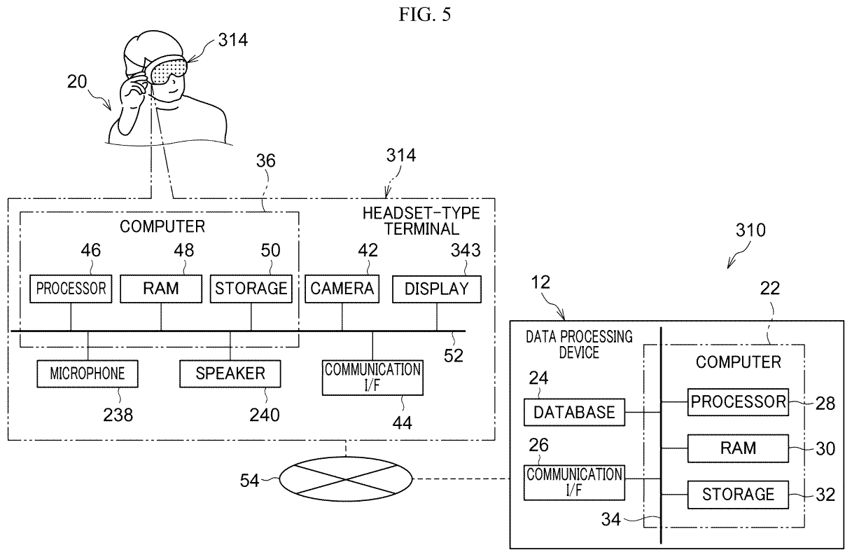

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

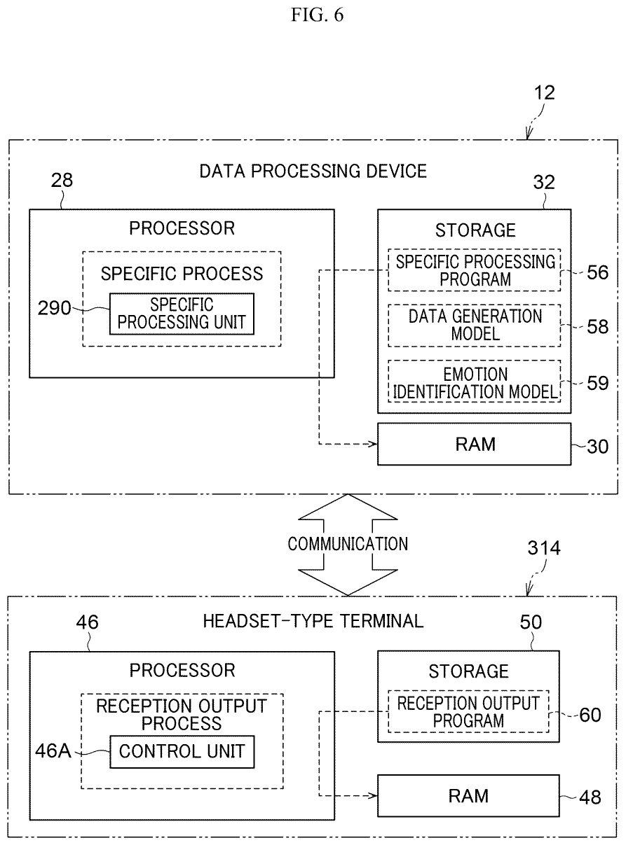

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

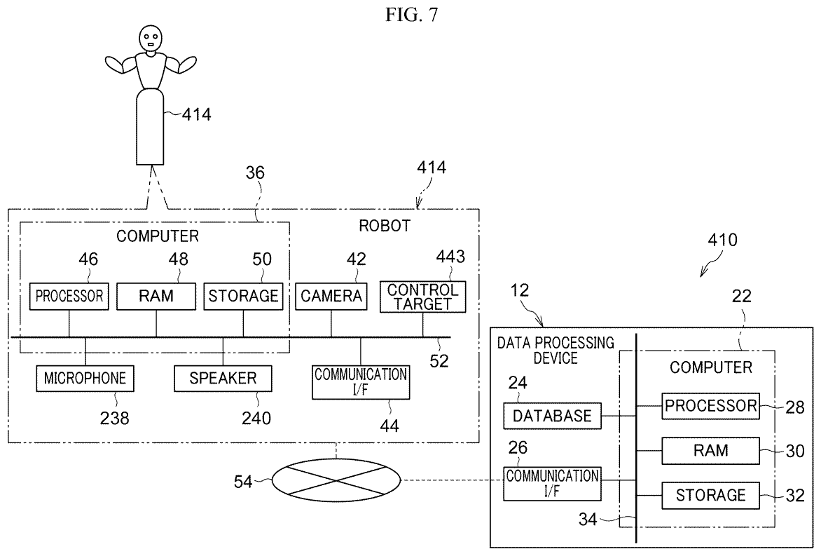

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

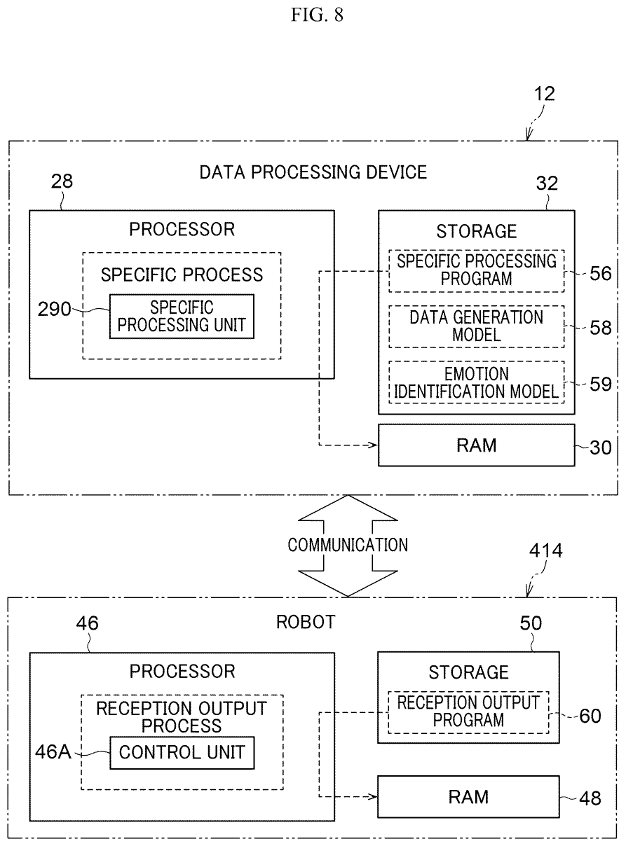

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

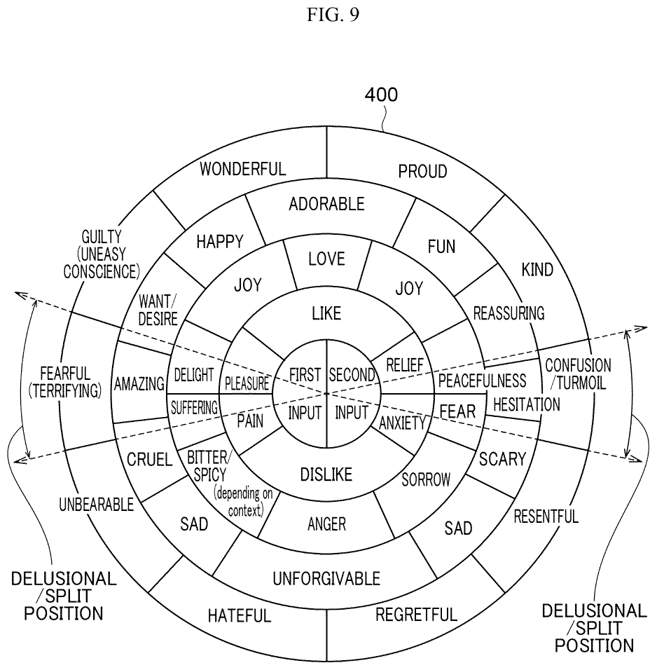

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci. nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

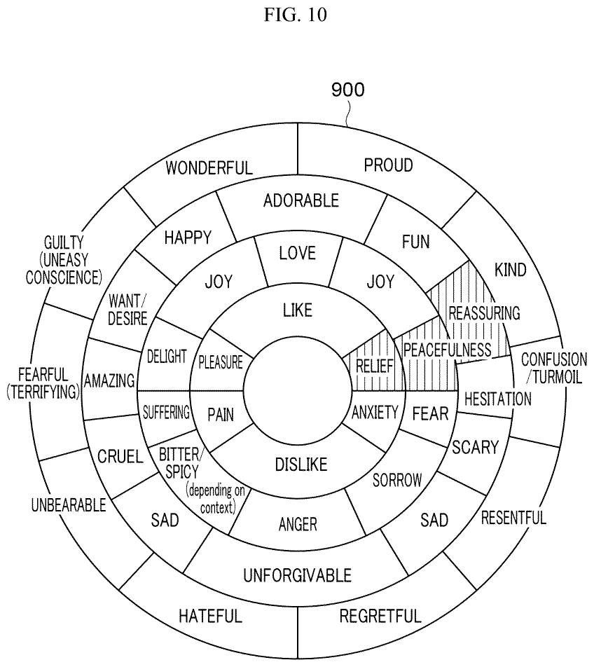

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire acoustic information via an acoustic input/output device and a communication control device of a terminal during a call, transmit the acoustic information to an information processing apparatus via a secure communication path, and store the acoustic information as acoustic data in a format that excludes personally identifiable information, and
apply an acoustic analysis program and an external acoustic analysis service to the acoustic data in the information processing apparatus so as to calculate acoustic feature quantities including at least pitch, speaking rate, intonation, intensity, and pausing pattern, and to calculate characteristic quantities indicative of a speaking tone, and then structure the characteristic quantities as non-personal acoustic feature data from which information having personal identifiability has been removed, and
register the non-personal acoustic feature data, together with an identifier and time information, in an information management mechanism on a storage device of the information processing apparatus, and retain the non-personal acoustic feature data in a format that enables search and reuse, and
apply a document analysis program to document data in the information processing apparatus so as to extract document feature quantities indicative of at least writing style, vocabulary selection, and syntactic structure, and store the document feature quantities as non-personal document feature data in association with the information management mechanism, and apply an image analysis program to image data in the information processing apparatus so as to extract appearance feature quantities of a person, and generate virtual person generation data that defines at least an appearance and a behavior of a virtual person to be displayed on a display device, based on the appearance feature quantities, the non-personal acoustic feature data, and the non-personal document feature data, and
generate a prompt sentence to be input to a generative AI model by using the non-personal document feature data in the information processing apparatus, supply the prompt sentence to the generative AI model so as to obtain generated document data reflecting the document feature quantities, and make the generated document data available in association with the virtual person generation data.

### Supplementary 2

The system according to supplementary 1,
wherein the processor is configured to
set control parameters of a speech synthesis program or an external speech synthesis service based on the characteristic quantities included in the non-personal acoustic feature data, including at least pitch, speaking rate, intonation, intensity, and pausing pattern, reproduce the speaking tone and voice characteristics as synthetic speech, and provide a pseudo-dialogue experience by using the generated document data together with the virtual person generation data.

### Supplementary 3

The system according to supplementary 1,
wherein the processor is configured to select at least a part of the non-personal acoustic feature data and the non-personal document feature data stored in the information management mechanism, automatically generate a prompt sentence for the generative AI model based on a result of the selection and instruction content received from a user, and output, in combination with the virtual person generation data, at least one of generated document data and generated speech control information that is produced based on the prompt sentence by the generative AI model.

Application Example 1

### Supplementary 1

A system comprising a processor,
wherein the processor is configured to
acquire an audio signal during a call via an audio input/output device, convert the audio signal into digital audio information, extract feature information indicating vocal characteristics and speaking tone of a speaker from the digital audio information, and generate, from the feature information, only derived information that does not include personal identification information, and
generate semantic information corresponding to the vocal characteristics and the speaking tone of the speaker on the basis of the feature information, and generate a prompt sentence including the semantic information for instructing a generative AI model to perform content recommendation, and
input the prompt sentence into the generative AI model to cause the generative AI model to generate text information, select a group of candidate audio information contents on the basis of the text information, and output recommendation information including the group of candidate audio information contents so as to be presentable on a terminal device, and
associate and store, as storage information, the feature information relating to the vocal characteristics and the speaking tone acquired from the call, feature information indicating speaker-likeness extracted from text information, and virtual person information generated from image information, and
provide a personalized communication experience and content presentation experience for the speaker by integrally using the vocal characteristics and the speaking tone of the speaker, the speaker-likeness of the text, and the virtual person information on the basis of the storage information.

### Supplementary 2

The system according to supplementary 1,
wherein the processor is configured to
generate audio information and text information that reproduce the vocal characteristics and the speaking tone of the speaker on the basis of the feature information and the storage information, and output the audio information and the text information as dialogue information that enables a pseudo communication experience with the speaker.

### Supplementary 3

The system according to supplementary 1,
wherein the processor is configured to
generate, in order to reproduce the feature information indicating the speaker-likeness of the text information, a prompt sentence for instructing text generation using the generative AI model, cause the generative AI model to generate text information on the basis of the prompt sentence, and use the generated text information as the dialogue information and the content recommendation information.

### Example 2

### Supplementary 1

A system comprising a processor,
wherein the processor is configured to
receive, from a terminal, structured information including past character information, remove user identification information and associated information from the structured information, and extract the character information,
execute natural language processing on the character information, the natural language processing including segmentation into morpheme units and calculation of statistical values, and generate language feature information including frequent expressions and style feature quantities,
store the language feature information in storage information in association with each user and maintain the language feature information as a user language profile that is referable in subsequent generation processing,
receive, from the terminal, generation request information including a prompt sentence for a generative AI model, and generate generation instruction information by adding style condition information to the prompt sentence based on the user language profile, input the generation instruction information to the generative AI model, obtain response character information reflecting the user language profile, and output the response character information to the terminal,
extract voice quality feature quantities and speaking-tone feature quantities from voice information acquired from a call, and store the voice quality feature quantities and the speaking-tone feature quantities in the storage information in association with the user language profile, and
analyze past image information to extract person appearance feature quantities, generate virtual person information based on the person appearance feature quantities, and store the virtual person information in the storage information in association with the user language profile and the voice quality feature quantities.

### Supplementary 2

The system according to supplementary 1,
wherein the processor is configured to
generate synthetic voice information based on the response character information and the voice quality feature quantities, and output the synthetic voice information to the terminal to provide a pseudo-communication experience by voice that imitates a speaking tone of a user.

### Supplementary 3

The system according to supplementary 1,
wherein the processor is configured to
add the style condition information and word-usage condition information to the prompt sentence for the generative AI model using the frequent expressions and the style feature quantities included in the language feature information, and thereby instruct the generative AI model to generate text that reproduces a user-specific individuality.

### Application Example 2 Supplementary 1

A system comprising a processor,
wherein the processor is configured to
acquire voice signals from a call, extract acoustic feature quantities and speech prosody from the voice signals in a format in which a speaker cannot be identified, and store the extracted acoustic feature quantities as numerical data,
acquire text information from message data, analyze vocabulary usage tendencies, sentence structures, writing style patterns, and emotional tendencies by natural language processing, generate style feature quantities indicating user-specific expression characteristics, and store the style feature quantities,
detect a face region from image data, extract facial feature points and shape parameters, generate feature information for a virtual person model, and generate a virtual person as a three-dimensional shape model or a two-dimensional character model based on the feature information,
analyze image frames acquired from an imaging element of a terminal device, detect user facial feature points, facial expression changes, and head movements, and generate a sequence of expression parameters for real-time control of expressions and movements of the virtual person,
estimate user preference information and emotional states based on the acoustic feature quantities, the style feature quantities, and the sequence of expression parameters, and generate and store user profile data including the preference information and the emotional states,
construct a prompt sentence to be input to a generative information processing model according to the user profile data and a current usage situation, transmit the prompt sentence to the generative information processing model, and acquire response data from the generative information processing model, and
generate, based on the response data, content candidates, dialogue sentences, or behavior instructions for the virtual person, and output the content candidates, the dialogue sentences, or the behavior instructions to the terminal device.

### Supplementary 2

The system according to supplementary 1,
wherein the processor is configured to execute processing of searching video content or audio content by using an information acquisition function of an external information providing apparatus based on the response data, selecting content candidates suitable for the user profile data, and presenting the selected content candidates to the terminal device.

### Supplementary 3

The system according to supplementary 1,
wherein the processor is configured to perform emotion analysis based on the acoustic feature quantities, the style feature quantities, and the sequence of expression parameters, obtain an emotion index, add the emotion index to the prompt sentence, and thereby change a style and content of the dialogue sentences or the content candidates generated by the generative information processing model in accordance with a user emotional state.

What is claimed is:

1. A system comprising:
circuitry configured to:
receive, via a communication interface coupled to a packet-switched network, acoustic information from a terminal device, convert the acoustic information into acoustic data in a format that excludes personally identifiable information, and store the acoustic data in a storage device;
apply an acoustic analysis program to the acoustic data to compute acoustic feature quantities comprising pitch, speaking rate, intonation, intensity, and pausing pattern, compute characteristic quantities indicative of a speaking tone, and structure the characteristic quantities as non-personal acoustic feature data;
apply a document analysis program to document data to extract document feature quantities indicative of writing style, vocabulary selection, and syntactic structure, and store the document feature quantities as non-personal document feature data in association with the non-personal acoustic feature data in the storage device;
apply an image analysis program to image data to extract appearance feature quantities of a person and generate virtual person generation data defining at least an appearance and a behavior of a virtual person based on the appearance feature quantities, the non-personal acoustic feature data, and the non-personal document feature data; and
generate a prompt sentence using the non-personal document feature data, input the prompt sentence to a generative neural network model to obtain generated document data reflecting the document feature quantities, and store the generated document data in association with the virtual person generation data in the storage device.

2. The system of claim 1, wherein the circuitry is configured to extract the acoustic feature quantities by applying a signal processing pipeline that computes fundamental frequency contours for the pitch, syllable duration statistics for the speaking rate, energy envelope profiles for the intensity, and silence gap durations for the pausing pattern from framed acoustic data segments.

3. The system of claim 2, wherein the circuitry is configured to apply an acoustic classification model to the computed acoustic feature quantities to produce a speaking tone category label and a speaking tone intensity score as the characteristic quantities indicative of the speaking tone.

4. The system of claim 3, wherein the circuitry is configured to structure the characteristic quantities as non-personal acoustic feature data by replacing source identifiers with an anonymized session identifier and verifying that no re-identification path exists before storing the non-personal acoustic feature data in the storage device.

5. The system of claim 4, wherein the non-personal acoustic feature data is registered in an information management index in the storage device together with the anonymized session identifier and a timestamp, the index being configured to enable search and retrieval by feature quantity range queries.

6. The system of claim 1, wherein the document analysis program applies a natural language processing pipeline to the document data comprising tokenization, part-of-speech tagging, dependency parsing, and vocabulary frequency analysis, and the document feature quantities are derived from the output of the natural language processing pipeline.

7. The system of claim 6, wherein the circuitry is configured to compute writing style feature vectors by applying term frequency-inverse document frequency weighting to vocabulary selection data and by computing average dependency parse depth and sentence length statistics from the syntactic structure analysis.

8. The system of claim 7, wherein the prompt sentence is generated by embedding the writing style feature vectors and the syntactic structure features as structured input sections that condition the generative neural network model to produce generated document data having lexical density and syntactic complexity aligned with the document feature quantities.

9. The system of claim 1, wherein the image analysis program applies a convolutional neural network to the image data to detect facial regions and extract appearance feature vectors comprising facial geometry parameters and texture descriptors.

10. The system of claim 9, wherein the virtual person generation data comprises a parametric appearance model defined by the appearance feature vectors, a motion behavior model defined by animation parameters derived from the non-personal acoustic feature data, and a speech behavior model defined by speaking rate and intonation parameters from the acoustic feature quantities.

11. The system of claim 10, wherein the circuitry is configured to synchronize the generated document data with the virtual person generation data by associating text tokens of the generated document data with animation frame intervals derived from the motion behavior model.

12. The system of claim 1, wherein applying the acoustic analysis program further comprises invoking an external acoustic analysis service via the communication interface, transmitting the acoustic data as a request payload, and receiving computed acoustic feature quantities as a response payload.

13. The system of claim 12, wherein the circuitry is configured to validate the acoustic feature quantities received from the external acoustic analysis service by cross-checking against locally computed baseline feature estimates and discarding outlier values exceeding a deviation threshold.

14. The system of claim 1, wherein the circuitry is configured to generate a plurality of prompt sentences from the non-personal document feature data, each prompt sentence conditioned on a different target content type, and select among the generated document data outputs based on a relevance score computed by the generative neural network model.

15. The system of claim 14, wherein the relevance score is computed by encoding each generated document data output as a feature vector using a text encoder component of the generative neural network model and computing cosine similarity between each encoded output and a reference feature vector derived from the non-personal document feature data.

16. The system of claim 1, wherein the circuitry is configured to update the virtual person generation data by triggering recomputation of the appearance feature quantities when new image data is received via the communication interface, and to blend updated appearance feature vectors with previously stored feature vectors using an exponential moving average.

17. The system of claim 1, wherein the circuitry is configured to transmit the virtual person generation data and the generated document data to the terminal device via the communication interface for rendering of a virtual person with associated generated content on a display of the terminal device.

18. A system comprising:
circuitry configured to:
receive, via a communication interface coupled to a packet-switched network, acoustic information from a terminal device, apply a signal processing pipeline to compute acoustic feature quantities comprising pitch contours, speaking rate statistics, intonation profiles, intensity envelopes, and pausing patterns, and structure the computed quantities as non-personal acoustic feature data by replacing source identifiers with an anonymized session identifier;
apply a natural language processing pipeline comprising tokenization, part-of-speech tagging, dependency parsing, and vocabulary frequency analysis to document data to extract document feature quantities, and compute writing style feature vectors using term frequency-inverse document frequency weighting and syntactic complexity statistics;
apply a convolutional neural network to image data to extract appearance feature vectors and generate virtual person generation data comprising a parametric appearance model, a motion behavior model derived from the non-personal acoustic feature data, and a speech behavior model derived from the acoustic feature quantities;
generate a prompt sentence embedding the writing style feature vectors and syntactic structure features as structured input sections and input the prompt sentence to a generative neural network model to produce generated document data conditioned on lexical density and syntactic complexity targets; and
associate the generated document data with the virtual person generation data by synchronizing text tokens with animation frame intervals derived from the motion behavior model, and store the associated data in a storage device.

19. The system of claim 18, wherein the circuitry is configured to compute a cosine similarity relevance score between encoded generated document data outputs and a reference feature vector derived from the document feature quantities, and select the highest-scoring generated document data output for association with the virtual person generation data.

20. A method comprising:
receiving, via a communication interface coupled to a packet-switched network, acoustic information from a terminal device, converting the acoustic information into acoustic data excluding personally identifiable information, and applying an acoustic analysis program to compute acoustic feature quantities comprising pitch, speaking rate, intonation, intensity, and pausing pattern;
applying a document analysis program to document data to extract document feature quantities indicative of writing style, vocabulary selection, and syntactic structure;
applying an image analysis program to image data to extract appearance feature quantities and generating virtual person generation data based on the appearance feature quantities, the acoustic feature quantities, and the document feature quantities;
generating a prompt sentence using the document feature quantities and inputting the prompt sentence to a generative neural network model to produce generated document data reflecting the document feature quantities; and
storing the generated document data in association with the virtual person generation data.
